(19) United States
(12) Patent Application Publication
(10) Pub. No.: US 2016/0203036 A1
(43) Pub. Date: Jul. 14, 2016

(54) MACHINE LEARNING-BASED FAULT DETECTION SYSTEM

(71) Applicant: Ecorithm, Inc., Goleta, CA (US)

(72) Inventors: Igor Mezic, Goleta, CA (US); Michael Vincent Georgescu, Los Angeles, CA (US); Gabriel Sebastian Peschiera, Brooklyn, NY (US); Donald William Kasper III, Auburn, NY (US); Sophie Marie Louise Loire, Oak View, CA (US)

(21) Appl. No.: 14/990,559

(22) Filed: Jan. 7, 2016

Related U.S. Application Data
(60) Provisional application No. 62/101,865, filed on Jan. 9, 2015.
(60) Provisional application No. 62/108,478, filed on Jan. 27, 2015.

(51) Int. Cl. G06F 11/07; G06N 7/00; G06N 99/00

(52) U.S. Cl. CPC G06F 11/079; G06N 99/005; G06N 7/005; G06F 11/0751

(57) ABSTRACT

Various systems and methods are provided that detect faults in data-based systems utilizing techniques that stem from the field of spectral analysis and artificial intelligence. For example, a data-based system can include one or more sensors associated with a subsystem that measure time-series data. A set of indicator functions can be established that define anomalous behavior within a subsystem. The systems and methods disclosed herein can, for each sensor, analyze the time-series data measured by the respective sensor in conjunction with one or more indicator functions to identify anomalous behavior associated with the respective sensor of the subsystem. A spectral analysis can then be performed on the analysis to generate spectral responses. Clustering techniques can be used to bin the spectral response values and the binned values can be compared with fault signatures to identify faults. Identified faults can then be displayed in a user interface.

### CROSS-REFERENCE TO RELATED APPLICATIONS

This application claims priority under 35 U.S.C. §119(e) to U.S. Provisional Patent Application No. 62/101,865, entitled “GENERAL STRUCTURE OF KOOPMAN SPECTRUM-BASED FAULT DETECTION” and filed on Jan. 9, 2015, and U.S. Provisional Application No. 62/108,478, entitled “FAULT TRACKING SYSTEM” and filed on Jan. 27, 2015, which are hereby incorporated by reference herein in their entireties.

### TECHNICAL FIELD

The present disclosure relates to systems and techniques for using machine learning to identify components of a building that are malfunctioning.

### BACKGROUND

Office buildings consume 40% of the energy used in the United States, and 70% of the electricity used in the United States. Energy consumption—whether electrical, fossil fuel, or other energy usage—has become a topic of concern not only for the efficient use of resources, but also because of its global impact.

Since interest in the efficient use of energy is high, technologies and tools that aid designers or building owners in providing comfortable, clean, and efficient buildings have been in use for many years. For example, such technologies and tools can include building management systems that monitor and control building performance. However, the building management systems can fail or malfunction, reducing the expected benefits.

### SUMMARY

The systems, methods, and devices described herein each have several aspects, no single one of which is solely responsible for its desirable attributes. Without limiting the scope of this disclosure, several non-limiting features will now be discussed briefly.

Disclosed herein are various systems and methods for detecting faults in data-based systems utilizing techniques that stem from the field of spectral analysis and artificial intelligence. For example, a data-based system can include one or more subsystems, where individual subsystems are associated with one or more sensors (or other electronic devices, such as Internet of Things (IoT) devices) that measure time-series data. A set of indicator functions can be established that define anomalous behavior within a subsystem. The systems and methods disclosed herein can, for each sensor of a subsystem, analyze the time-series data measured by the respective sensor in conjunction with one or more indicator functions to identify anomalous behavior associated with the respective sensor of the subsystem. The identified anomalous behavior can be represented as a set of anomalous behavior time-series data, where each individual anomalous behavior time-series data corresponds to a sensor and indicator function combination.

The systems and methods disclosed herein can then decompose the anomalous behavior time-series data in terms of spatial-temporal modes that describe the behavior of the sensors at different time-scales. For example, the anomalous behavior time-series data can be converted into the frequency domain to describe anomalous behavior of the sensors at different time-scales. Clustering techniques can be used to bin or aggregate the values associated with various sensor and indicator function combinations and the binned values can be scored and/or ranked based on a level of coincidence and/or a level of severity. A set of fault signatures can be established that define a pattern of coincidence and/or severity levels for one or more indicator functions and/or sensors that indicate a likelihood that a specific fault has occurred. The systems and methods disclosed herein can compare the fault signatures with the scored and/or ranked binned values to identify faults that may have occurred and/or probabilities that the individual identified faults occurred. The systems and methods disclosed herein can generate an interactive user interface that displays the identified faults and/or the probabilities.

The systems and methods disclosed herein can include additional features to improve the accuracy of the fault detection. For example, heuristics (e.g., artificial intelligence, such as machine learning, support vector regression, support vector machines, ensemble methods, artificial neural networks, diffusion maps, etc.) can be used to identify previously unidentified faults and/or to remove false positive fault identifications. If a comparison of fault signatures and a portion of the scored and/or ranked binned values does not yield a match (e.g., the portion of the scored and/or ranked binned values do not equal the score and/or rank or fall within a range of scores and/or ranks that define the fault signature), but the portion of the scored and/or ranked binned values have a pattern that resembles that of a fault according to machine learning heuristics (e.g., the portion includes high coincidence and/or severity levels), then the systems and methods disclosed herein can suggest to a user that a fault has occurred and provide details of the analysis. Based on the feedback provided by the user on whether the portion corresponds to a fault, the systems and methods disclosed herein can suggest (or not suggest) a fault has occurred the next time similar coincidence and/or severity levels are identified for similar sensors and/or indicator functions. As another example, the systems and methods disclosed herein allow a user to define a physical, structural, and/or control relationship between sensors and/or subsystems. If the scored and/or ranked binned values of two sensors exhibit a high level of coincidence and/or severity, the systems and methods disclosed herein can decline to suggest that a fault has occurred in response to a determination that the two sensors are not physically and/or structurally related or in response to a determination that the two sensors are not controlled together (e.g., controlled by the same entity).

One aspect of the disclosure provides a fault detection system for detecting a fault in a data-based system. The fault detection system comprises a computing system comprising one or more computer processors; a database storing values measured by a sensor of a component in the data-based system; and a computer readable storage medium that stores program instructions that instruct the computing system to at least: retrieve, from the database, first values measured by the sensor during a first time period, apply, to each of the first values, a first indicator function in a plurality of indicator functions to generate a respective second value, process the second values using a spectral analysis to generate a plurality of third values, where each third value in the plurality of third values is associated with a magnitude value and a time period in a plurality of time periods, and where each third value in the plurality of third values corresponds with the first indicator function, retrieve a plurality of fault signatures, where each fault signature is associated with an indicator function in the plurality of indicator functions and a fault magnitude value, identify a first third value in the plurality of third values that is associated with a second time period in the plurality of time periods, compare the magnitude value of the first third value with the fault magnitude value of a first fault signature in the plurality of fault signatures, detect that a fault has occurred with a first probability in response to a determination that the fault magnitude value of the first fault signature matches the magnitude value of the first third value and that the indicator function associated with the first fault signature is the first indicator function, and display the detected fault in an interactive user interface.

The fault detection system of the preceding paragraph can have any sub-combination of the following features: where the first fault signature is associated with the fault magnitude value and a second fault magnitude value, and where the computer readable storage medium further stores program instructions that instruct the computing system to at least: retrieve, from the database, fourth values measured by a second sensor of the component during the first period of time, apply, to each of the fourth values, a second indicator function in the plurality of indicator functions to generate a respective fifth value, process the fifth values using the spectral analysis to generate a plurality of sixth values, where each sixth value in the plurality of sixth values is associated with a magnitude value and a time period in the plurality of time periods, identify a first sixth value in the plurality of sixth values that is associated with the first time period, compare the magnitude value of the first sixth value with the second fault magnitude value of the first fault signature, and detect that the fault has occurred in response to a determination that the fault magnitude value of the first fault signature matches the magnitude value of the first third value and that the second fault magnitude value of the first fault signature matches the magnitude value of the first sixth value; where the computer readable storage medium further stores program instructions that instruct the computing system to at least: bin the first third value and the first sixth value, and detect that a second fault has occurred in response to a determination that the binned first third value and the binned first sixth value exhibit a level of coincidence that exceeds a first threshold value and exhibit a level of severity that exceeds a second threshold value; where the level of coincidence corresponds with a level of similarity between two magnitude values; where the first indicator function defines an anomalous condition represented by a threshold value, and where the computer readable storage medium further stores program instructions that instruct the computing system to at least, for each of the first values: determine whether the respective first value exceeds the threshold value, assign the respective second value a high value in response to a determination that the respective first value exceeds the threshold value, and assign the respective second value a low value lower than the high value in response to a determination that the respective first value does not exceed the threshold value; where the computer readable storage medium further stores program instructions that instruct the computing system to at least: receive, via the interactive user interface, an indication that the detected fault is misdiagnosed, process the indication using artificial intelligence, and determine whether to display a second fault that corresponds with the detected fault in the interactive user interface at a later time based on results of the processing; where the component comprises one of an HVAC system, a variable air volume system, an air handling unit, a heat pump, or a fan powered box; and where the computer readable storage medium further stores program instructions that cause the computing system to process the second values using a Koopman mode analysis.

Another aspect of the disclosure provides a computer-implemented method for detecting a data-based system fault. The computer-implemented method comprises: as implemented by a fault detection server comprising one or more computing devices, the fault detection server configured with specific executable instructions, retrieving, from a sensor database, first values measured by a sensor of a component during a first time period; applying, to each of the first values, a first indicator function in a plurality of indicator functions to generate a respective second value; processing the second values using a spectral analysis to generate a plurality of third values, where each third value in the plurality of third values is associated with a magnitude value and a time period in a plurality of time periods; retrieving a plurality of fault signatures, where each fault signature is associated with an indicator function in the plurality of indicator functions and a fault magnitude value; identifying a first third value in the plurality of third values that is associated with a second time period in the plurality of time periods; comparing the magnitude value of the first third value with the fault magnitude value of a first fault signature in the plurality of fault signatures; detecting that a fault has occurred with a first probability in response to a determination that the fault magnitude value of the first fault signature falls within a range of the magnitude value of the first third value; and displaying the detected fault in an interactive user interface.

The computer-implemented method of the preceding paragraph can have any sub-combination of the following features: where the first fault signature is associated with the fault magnitude value and a second fault magnitude value, and where the method further comprises: retrieving, from the sensor database, fourth values measured by a second sensor of the component during the first period of time, applying, to each of the fourth values, a second indicator function in the plurality of indicator functions to generate a respective fifth value, processing the fifth values using the spectral analysis to generate a plurality of sixth values, where each sixth value in the plurality of sixth values is associated with a magnitude value and a time period in the plurality of time periods, identifying a first sixth value in the plurality of sixth values that is associated with the first time period, comparing the magnitude value of the first sixth value with the second fault magnitude value of the first fault signature, and detecting that the fault has occurred in response to a determination that the fault magnitude value of the first fault signature matches the magnitude value of the first third value and that the second fault magnitude value of the first fault signature matches the magnitude value of the first sixth value; where the computer-implemented method further comprises binning the first third value and the first sixth value, and detecting that a second fault has occurred in response to a determination that the binned first third value and the binned first sixth value exhibit a level of coincidence that exceeds a first threshold value and exhibit a level of severity that exceeds a second threshold value; where the level of coincidence corresponds with a level of similarity between two magnitude values; where the first indicator function defines an anomalous condition represented by a threshold value, and where applying, to each of the first values, a first indicator function comprises, for each of the first values: determining whether the respective first value exceeds the threshold value, assigning the respective second value a high value in response to a determination that the respective first value exceeds the threshold value, and assigning the respective second value a low value lower than the high value in response to a determination that the respective first value does not exceed the threshold value; where the first third value corresponds with the first indicator function, and where detecting that a fault has occurred comprises detecting that the fault has occurred in response to a determination that the fault magnitude value of the first fault signature matches the magnitude value of the first third value and the indicator function associated with the first fault signature is the first indicator function; where the computer-implemented method further comprises receiving, via the interactive user interface, an indication that the detected fault is misdiagnosed, processing the indication using artificial intelligence, and determining whether to display a second fault that corresponds with the detected fault in the interactive user interface at a later time based on results of the processing; where the component comprises one of an HVAC system, a variable air volume system, an air handling unit, a heat pump, or a fan powered box; and where processing the second values using a spectral analysis comprises processing the second values using a Koopman mode analysis.

Another aspect of the disclosure provides a non-transitory computer-readable medium having stored thereon a spectral analyzer and a fault detector for identifying faults in a data-based system, the spectral analyzer and fault detector comprising executable code that, when executed on a computing device, implements a process comprising: retrieving first values measured by a sensor of a component during a first time period; applying, to each of the first values, a first indicator function in a plurality of indicator functions to generate a respective second value; processing the second values using a spectral analysis to generate a plurality of third values, where each third value in the plurality of third values is associated with a magnitude value and a time period in a plurality of time periods; retrieving a plurality of fault signatures, where each fault signature is associated with a fault magnitude value; identifying a first third value in the plurality of third values that is associated with a second time period in the plurality of time periods; comparing the magnitude value of the first third value with the fault magnitude value of a first fault signature in the plurality of fault signatures; detecting that a fault has occurred with a first probability in response to a determination that the fault magnitude value of the first fault signature falls within a range of the magnitude value of the first third value; and displaying the detected fault in an interactive user interface.

The non-transitory computer-readable medium of the preceding paragraph can have any sub-combination of the following features: where the first indicator function defines an anomalous condition represented by a threshold value, and where the executable code further implement a processing comprising, for each of the first values: determining whether the respective first value exceeds the threshold value, assigning the respective second value a high value in response to a determination that the respective first value exceeds the threshold value, and assigning the respective second value a low value lower than the high value in response to a determination that the respective first value does not exceed the threshold value; and where the executable code further implement a processing comprising: receiving, via the interactive user interface, an indication that the detected fault is misdiagnosed, processing the indication using artificial intelligence, and determining whether to display a second fault that corresponds with the detected fault in the interactive user interface at a later time based on results of the processing.

### BRIEF DESCRIPTION OF THE DRAWINGS

FIG. 1 illustrates a block diagram showing the various components of a fault detection system.

FIG. 2A illustrates a table depicting the mapping of component information to a standard format.

FIG. 2B illustrates a graph structure representing the physical relationship between components and/or parameters associated with the physical structure of FIG. 1.

FIG. 3A illustrates a flow diagram illustrating the operations performed by the fault detection server of FIG. 1.

FIGS. 3B-3I depict graphs that graphically represent the operations performed by the fault detection server of FIG. 1.

FIGS. 4A-4B illustrate a user interface displaying a physical structure summary information for a plurality of physical structures.

FIGS. 5A-5B illustrate a user interface displaying the faults detected for a physical structure.

FIG. 6 illustrates a user interface displaying a graphical representation of a spectral response by floor and period in a physical structure.

FIG. 7 is a flowchart depicting an illustrative operation of detecting a fault in a data-based system.

### DETAILED DESCRIPTION OF SPECIFIC EMBODIMENTS

### Overview

As described above, building management systems can fail or malfunction, reducing building energy efficiency and producing waste. Typically, data can be collected from sensors associated with components within a building (e.g., sensors that measure data derived from heating, ventilating, and air conditioning (HVAC) systems, air handling units, fan powered boxes, variable air volume systems, etc.) and stored for analysis to determine when a component within a building has failed or is malfunctioning (e.g., a fault has occurred).

However, buildings are complicated systems. Many of the components within the building are interrelated and the outputs of sensors associated with one component can be affected by the operation of another component. Furthermore, many issues that result in faults can occur at a high-frequency or level of oscillation (e.g., measured values can swing from one extreme to another) over a period of time, occur at a consistently short duration over a long period of time, and/or the like. Thus, it can be very difficult for a human to simply view the stored sensor data and accurately identify faults that are occurring.

Some systems may use a set of rules to help identify faults within the stored data. A rule can specify that a fault has occurred if a predefined set of conditions exist across spatial and/or temporal fields. For example, a rule can specify that a fault has occurred if a first sensor measures a first value, a second sensor measures a second value, and so on, for a predetermined time interval of occurrences. Thus, rules rely on and are defined based on actual measured values. Rules are made up of conditions that ultimately result in either true or false, and thus the determination of whether a fault occurred is dependent on whether the result of a rule is true or false. However, as mentioned above, buildings are complicated systems and many of the building components are interrelated. To define a rule, it would be necessary to understand what outputs represent faulty behavior, how each component in the building operates (e.g., which might require knowing the make and model of each of the components in the building, the units of the measurements provided by the sensors of the component, etc.), and/or how each of the components are related. Thus, to identify potential faults, a user may need to define thousands of highly specific rules that correspond to just a single building. Defining rules in this manner is inefficient because such rules are not modular—the rules cannot be replicated and be used for other buildings (given that components in other buildings may be different makes or models, physically related in a different manner, etc.). In fact, occasionally component relationship information is not readily available, is outdated, and/or is otherwise incomplete. Accordingly, rules derived from incomplete data cannot be expected to provide reliable determinations on whether a fault occurred. Additionally, the output of a rule may be a true/false value that reflects whether a specified condition exists. Any change to the description of the rule (e.g., a change that results in the comparison of different sensor outputs, different values, different time intervals, etc.) may result in the creation of a new rule. Likewise, ruled-based systems may not be capable of comparing one rule to another rule unless the comparison is defined in a rule because the comparison itself would be a different rule. In practice, the very nature of rules leads to a proliferation of definitions in a rules-based system, and, due to the static nature of rules, the scope of applicability of rules-based systems is limited. Moreover, each time a component is replaced in a building, rules associated with the replaced component may need to be updated to account for the new component. Furthermore, these rules would only capture known faults or faults that can be linked to a set of sensor outputs. If the conditions that govern a fault are unknown or not easily definable, rules-based systems may be unable to identify such faults.

Accordingly, disclosed herein are various systems and methods for detecting faults in buildings utilizing techniques that stem from the field of spectral analysis and artificial intelligence. For example, a building can include one or more components (e.g., HVACs, air handling units, fan powered boxes, variable air volume systems, etc.), where individual components are associated with one or more sensors that measure time-series data. A set of indicator functions can be established that define anomalous behavior within a component. An indicator function is a simple algorithm that converts time-series data associated with one or more sensors (or derivatives of the time-series data) into a bitmap of true/false conditions (e.g., binary outputs) for each time instance. As an example, a first type or class of indicator function can define a setpoint (e.g., a measured value in the time-series data, such as 70 degrees) and determine whether the setpoint is exceeded (e.g., a true condition) or not exceeded (e.g., a false condition) over time. Other classes of indicator functions can define whether a component is unexpectedly on (e.g., enabled, functioning, operational, etc.), whether an actuator is at an operational limit, whether the value of an output of a type of sensor is outside of a value range that is physically reasonable or possible, and/or the like. As another example, an indicator function can define an oscillation in the time-series data (e.g., a frequency of oscillation, a magnitude of oscillation, a phase of oscillation, etc.) and determine whether oscillation exceeds or does not exceed a threshold value. As another example, an indicator function can calculate a derivative of the time-series data (e.g., 2nd derivative, 3rd derivative, etc.) and determine whether the derivative exceeds or does not exceed a threshold value.

A fault detection system can, for each sensor of a component, analyze the time-series data measured by the respective sensor using one or more indicator functions to identify anomalous behavior associated with the respective sensor of the component. For example, the fault detection system can convert the time-series data measured by the respective sensor into another time-series, where each data point in the new time-series corresponds to whether a true or false condition occurred at the given time instance. The identified anomalous behavior may then be time instances in which a true condition occurred (or, alternatively, in which a false condition occurred). A new time-series may be generated for each indicator function that is used to analyze the time-series data of the respective sensor. Thus, the fault detection system can generate a set of new time-series, where each time-series in the set corresponds to a sensor and indicator function combination. As used herein, the new time-series can also be referred to as an anomalous behavior time-series.

The fault detection system can then decompose the new time-series data in terms of spatial-temporal modes that describe the behavior of the sensors at different time-scales. For example, the new time-series data can be converted into the frequency domain to describe anomalous behavior of the sensors at different time-scales. Clustering techniques (e.g., K-means clustering, hierarchical clustering, etc.) can be used by the fault detection system to bin or aggregate the values (e.g., magnitudes in the frequency domain, phases in the frequency domain, combinations of magnitudes and phases in the frequency domain, etc.) associated with various sensor and indicator function combinations and the binned values can be scored and/or ranked based on a level of coincidence (e.g., how similar values are in magnitude, phase, and/or period of occurrence) and/or a level of severity (e.g., the higher the magnitude and/or phase value, the higher the severity level). A user and/or the fault detection system can establish a set of fault signatures that indicate the characteristics of the occurrence of a specific class of fault. The fault signatures can define a pattern of coincidence and/or severity levels for one or more indicator functions and/or sensors that correspond to the specific fault. The fault detection system can compare the fault signatures with the scored and/or ranked binned values to identify faults that potentially have occurred. The fault detection system can generate an interactive user interface that displays the identified faults and/or statistics corresponding to a likelihood that the identified faults occurred.

In an embodiment, the fault detection system provides additional features to improve the accuracy of the fault detection. For example, heuristics (e.g., artificial intelligence, such as machine learning, support vector regression, support vector machines, ensemble methods, artificial neural networks, diffusion maps, etc.) can be used to identify previously unidentified faults and/or to remove false positive fault identifications. If a comparison of fault signatures and a portion of the scored and/or ranked binned values does not yield a match (e.g., the portion of the scored and/or ranked binned values do not equal the score and/or rank or fall within a range of scores and/or ranks that define the fault signature), but the portion of the scored and/or ranked binned values have a pattern that resembles that of a fault according to machine learning heuristics (e.g., the portion includes high coincidence and/or severity levels), then the fault detection system can suggest to a user that a fault has occurred and provide details of the analysis (e.g., component(s) that triggered the fault, the periodicity of the potential fault, etc.). Based on feedback provided by the user on whether the portion corresponds to an actual fault, the fault detection system can suggest (or not suggest) a fault has occurred the next time similar coincidence and/or severity levels are identified for similar sensors and/or indicator functions. As another example, the fault detection system can allow a user to define a physical, structural, and/or control relationship between sensors and/or components. If the scored and/or ranked binned values of two sensors exhibit a high level of coincidence and/or severity, the fault detection system can decline to suggest that a fault has occurred in response to a determination that the two sensors are not physically and/or structurally related or in response to a determination that the two sensors are not controlled together (e.g., controlled by the same entity).

In this way, by using indicator functions, spectral analysis, and machine learning, the techniques implemented by the fault detection system are modular and can be applied to any building, regardless of the components installed in the building or their relationship with each other. For example, unlike a rule, the fault detection system does not rely on how an individual component operates (and how that operation differs from other makes or models of the same type of component), the units in which a sensor outputs data, and/or how components are related to each other. Rather, the fault detection process as described herein can, for example, be broken into three concepts: (1) an indicator function provides a general indication of how a component is behaving (e.g., a component is on, a component is off, a component is cooling, a component is warming, etc.) over time (without a user specifying a time interval for the occurrence of a condition) and thus can be applied to a class of components (not just an individual make and model of component within the class); (2) the characteristics of the occurrence of a condition over time (e.g., daily, weekly, seasonally, annually, etc.) can be represented via a spectral analysis (e.g., by performing a spectral analysis on the output of an indicator function); and (3) the likelihood of the occurrence of a fault can be evaluated by applying machine learning to the spectral values of a single indicator function and/or the coincidence and/or severity of spectral values from multiple indicator functions. Because the indicator functions can apply generally to classes of components and do not rely on the relationships between components, the same indicator functions can be used for different buildings and/or if components are replaced with different makes and/or models.

Furthermore, spectrally analyzing the results of an application of an indicator function allows for the fault detection system to identify previously unknown faults. For example, the spectral analysis of an indicator function allows the fault detection system to detect abnormalities corresponding to one or more sensors, where the abnormalities have occurred simultaneously or nearly simultaneously (or at similar intervals of time) at a similar coincidence and/or severity level. Thus, unlike a rules-based system, indicator function(s) can be used to detect a fault even if the underlying conditions that caused the fault to occur are previously unknown.

While the systems and methods disclosed herein are described with respect to sensors in buildings or other physical structures, this is merely for illustrative purposes and is not meant to be limiting. The systems and methods disclosed herein can be applied to measurements received from any type of electronic device, such as an Internet of Things (IoT) device (e.g., a device that allows for secure, bi-direction communication over a network, such as an actuator, a light, a coffee machine, an appliance, etc.), associated with any data-based system (e.g., systems associated with healthcare, agriculture, retail, finance, energy, industry, etc.).

### Exemplary System Overview

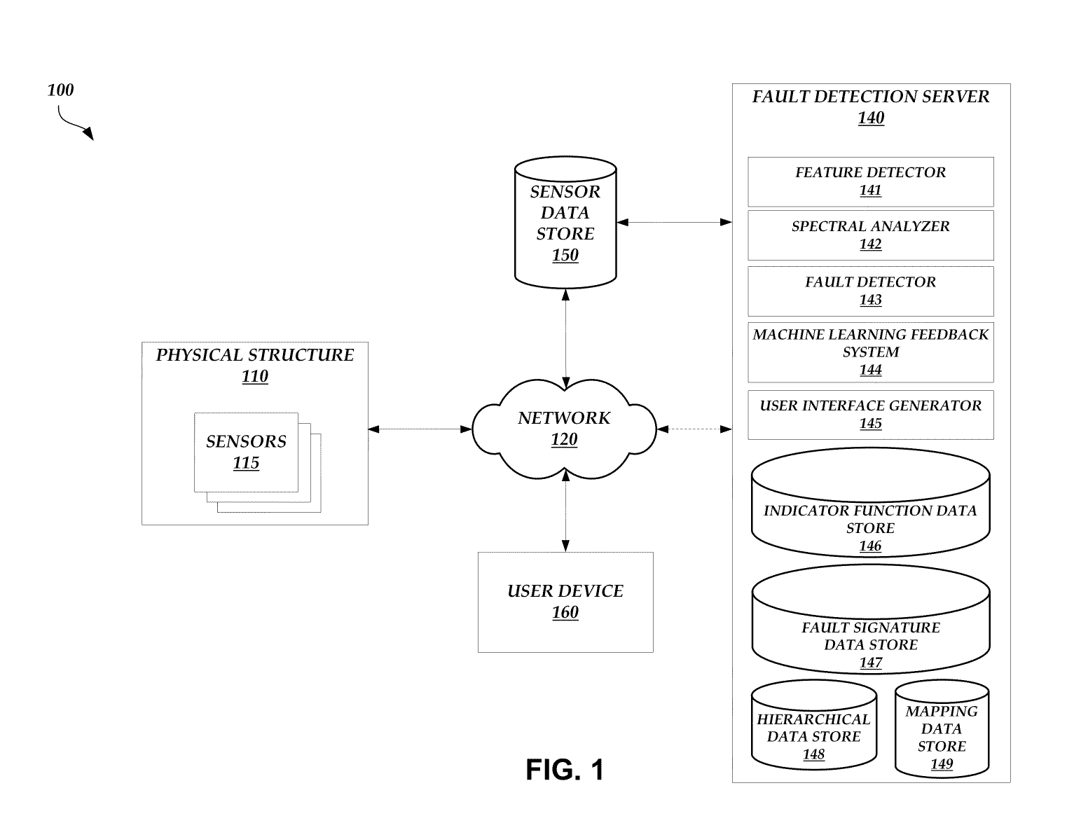

FIG. 1 illustrates a block diagram showing the various components of a fault detection system 100. As illustrated in FIG. 1, the fault detection system 100 may include a physical structure 110 (e.g., a building with one or more components), a fault detection server 140, a sensor data store 150, and a user device 160. In an embodiment, the physical structure 110 (e.g., a building management system within the physical structure 110) and the sensor data store 150 communicate via a network 120. In some embodiments, the physical structure 110 further communicates with the fault detection server 140 via the network 120. In other embodiments, the fault detection server 140 may be located on-site, within the physical structure 110, and be housed within a server or series of servers. Similarly, the functionality disclosed with reference to these components may be distributed to other computing devices and/or partially performed by multiple computing devices.

The physical structure 110 may be a structure that comprises various components and/or equipment. Such components and/or equipment can include HVAC systems, air handling units, fan powered boxes, variable air volume systems, cooling towers, condenser water loops, heat recovery wheels, rooftop terminal units, heat pumps, and/or the like. The physical structure 110 may further include a plurality of sensors 115 that detect or measure physical properties, such as voltage, current, pressure, air flow, temperature, and/or the like over a period of time. Some or all of the components or equipment within the physical structure 110 can each be associated with one or more sensors 115. For example, an air handling unit can include a first sensor 115 that measures supply air temperature, a second sensor 115 that measures static pressure, and so on. A sensor 115 (or the component or equipment associated with a sensor 115) can be associated with a location within the physical structure 110.

The fault detection server 140 may include various modules. For example, the fault detection server 140 may include a feature detector 141, a spectral analyzer 142, a fault detector 143, a machine learning feedback system 144, a user interface generator 145, an indicator function data store 146, a fault signature data store 147, a hierarchical data store 148, and a mapping data store 149. References herein to “data store” may refer to any type of data structure for storing and/or organizing data, including, but not limited to, relational databases (for example, Oracle database, mySQL database, and the like), spreadsheets, XML files, and text files, among others. The various terms “database,” “data store,” and “data source” may be used interchangeably in the present disclosure. A “file system” may control how data is stored and/or retrieved (for example, a disk file system like FAT, NTFS, optical discs, etc., a flash file system, a tape file system, a database file system, a transactional file system, a network file system, etc.). For simplicity, the disclosure is described herein with respect to data stores. However, the systems and techniques disclosed herein may be implemented with file systems or a combination of data stores and file systems.

In an embodiment, the feature detector 141, the spectral analyzer 142, the fault detector 143, the machine learning feedback system 144, and the user interface generator 145 are each implemented as executable code modules that are stored in the memory of, and executed by the processor(s) of, the fault detection server 140. The feature detector 141, the spectral analyzer 142, the fault detector 143, the machine learning feedback system 144, and the user interface generator 145 may also be implemented partly or wholly in application-specific hardware.

The feature detector 141 is configured to determine which indicator function(s) should be used to analyze a given physical structure 110. For example, the user can provide, via a user interface generated by the user interface generator 145, information on the components within the physical structure 110 and/or how the components are physically interrelated. Alternatively, this information can be received directly from the physical structure 110 via a building management system. The information on the components within the physical structure 110 can be provided in any format and the feature detector 141 can map the provided information to a uniform format.

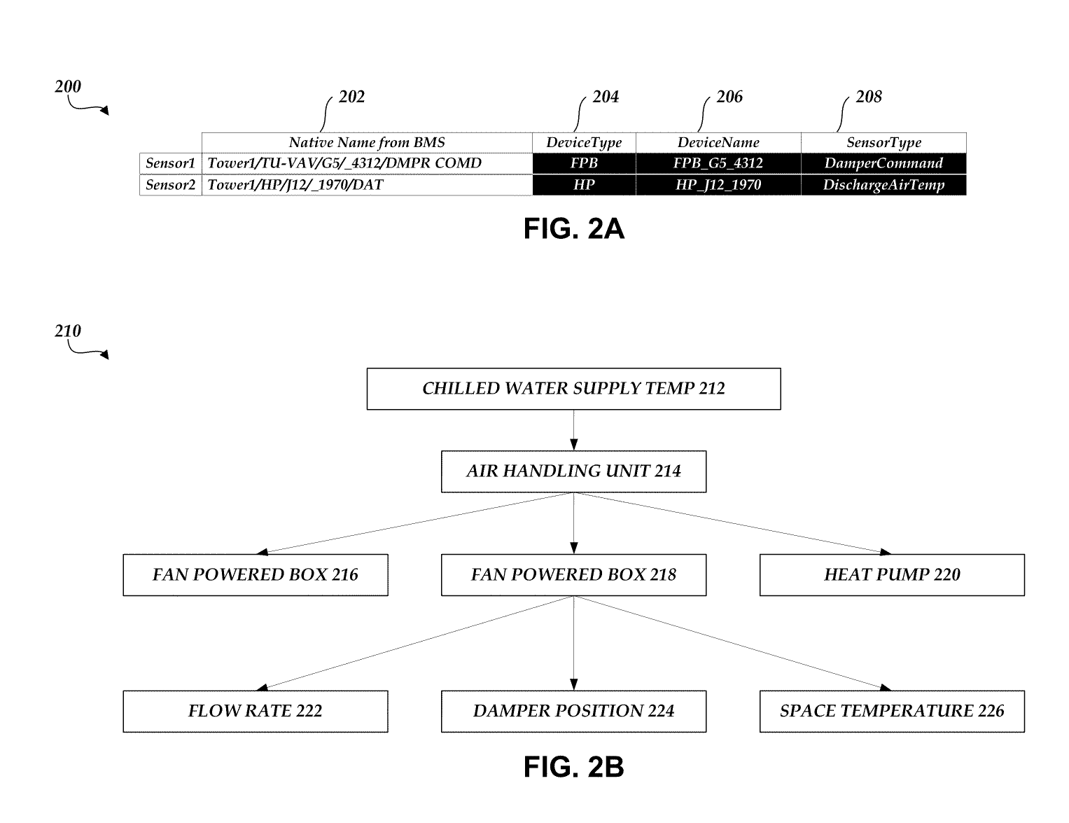

For example, FIG. 2A illustrates a table 200 depicting the mapping of component information to a standard format. As illustrated in FIG. 2A, a building management system provides two long phrases in column 202 that each identify a name of the physical structure 110 (e.g., Tower 1), a name of a class of component (e.g., fan powered box, a heat pump, etc.), a name for the specific component in the class (e.g., FPB_G5_4312, HP_J12_1970, etc.), and a type of sensor associated with the specific component (e.g., damper command, discharge air temperature, etc.). The feature detector 141 can map the provided information into, for example, three columns 204, 206, and 208 that break up the provided phrase into discrete pieces of information using standard language. The mapping can be stored in the mapping data store 149.

The feature detector 141 can retrieve the mapping from the mapping data store 149, use the standard format to identify the components in the physical structure 110, and retrieve indicator functions that correspond to the identified components from the indicator function data store 146.

In addition, the feature detector 141 can retrieve and/or store information on how the components are physically interrelated. For example, FIG. 2B illustrates a graph structure 210 representing the physical relationship between components and/or parameters associated with the physical structure 110. As illustrated in FIG. 2B, a type of sensor that measures chilled water supply temperature 212 affects the operation of a component identified as air handling unit 214. The operation of the air handling unit 214 affects the operation of components fan powered box 216, fan powered box 218, and heat pump 220. The operation of the fan powered box 218 is measured by sensors that measure flow rate 222, damper position 224, and space temperature 226. Thus, for example, the graph structure 210 identifies a physical relationship between the air handling unit 214 and the fan powered box 218 and a physical relationship between the flow rate 222 and the damper position 224. However, there may not be a relationship between the heat pump 220 and the flow rate 222. This relationship information can be stored in the hierarchical data store 148 for retrieval by the machine learning feedback system 144 for the purpose of removing false positives, as described herein.

The feature detector 141 can also apply one or more indicator functions to the outputs of the sensors 115. The feature detector 141 can retrieve the time-series data measured by the sensors 115 from the sensor data store 150 or directly from the sensors 115 via the network 120. In an embodiment, indicator functions correspond to specific types of sensors and/or specific classes of components. Thus, the mapping of the provided information into the standard format or language allows the feature detector 141 to determine which indicator functions are to be applied to any given time-series dataset. For example, a specific type of sensor corresponds to a specific standard term, and the indicator functions that correspond to the specific type of sensor then correspond with the specific standard term. When time-series data from a specific type of sensor is analyzed, the feature detector 141 can identify the specific standard term corresponding to the specific type of sensor and retrieve the indicator functions corresponding to the specific standard term. Thus, the feature detector 141 can apply the indicator functions to the time-series data of the appropriate sensors 115.

The feature detector 141 can apply one or more indicator functions to the time-series data associated with some or all of the sensors 115. For example, if two indicator functions are associated with a first sensor 115 and three indicator functions are associated with a second sensor 115, then the feature detector 141 can apply the first indicator function to the time-series data of the first sensor 115, the second indicator function to the time-series data of the first sensor 115, the third indicator function to the time-series data of the second sensor 115, the fourth indicator function to the time-series data of the second sensor 115, and the fifth indicator function to the time-series data of the second sensor 115.

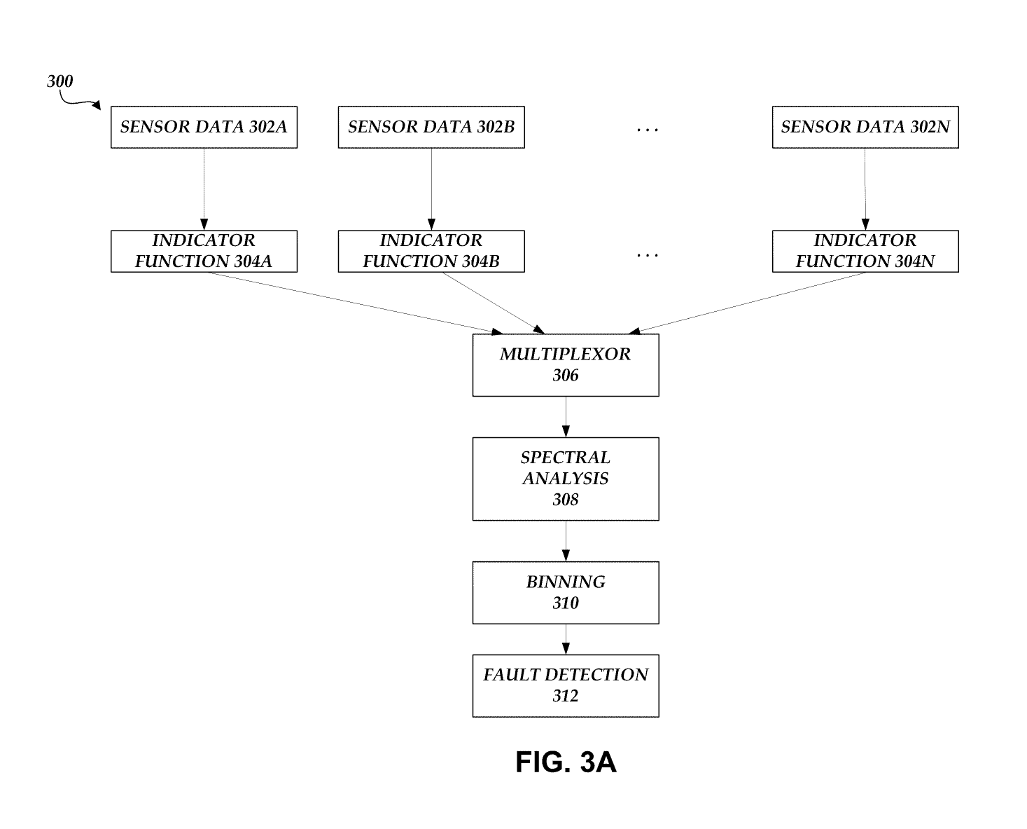

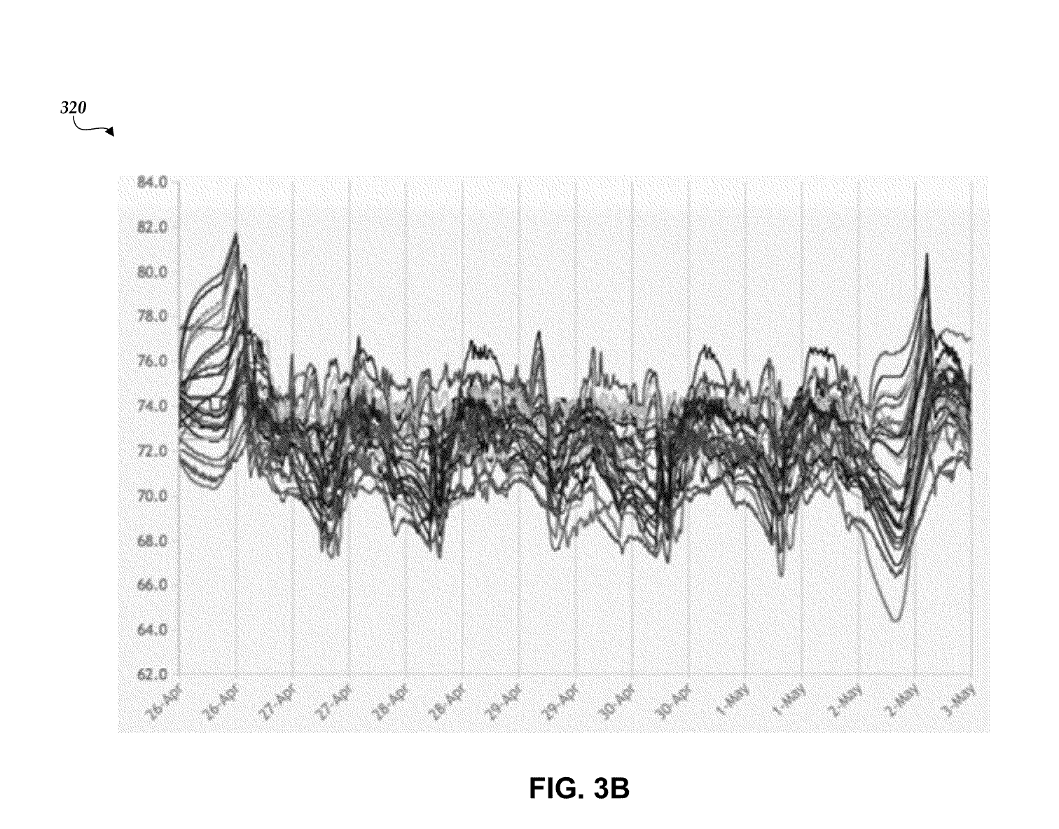

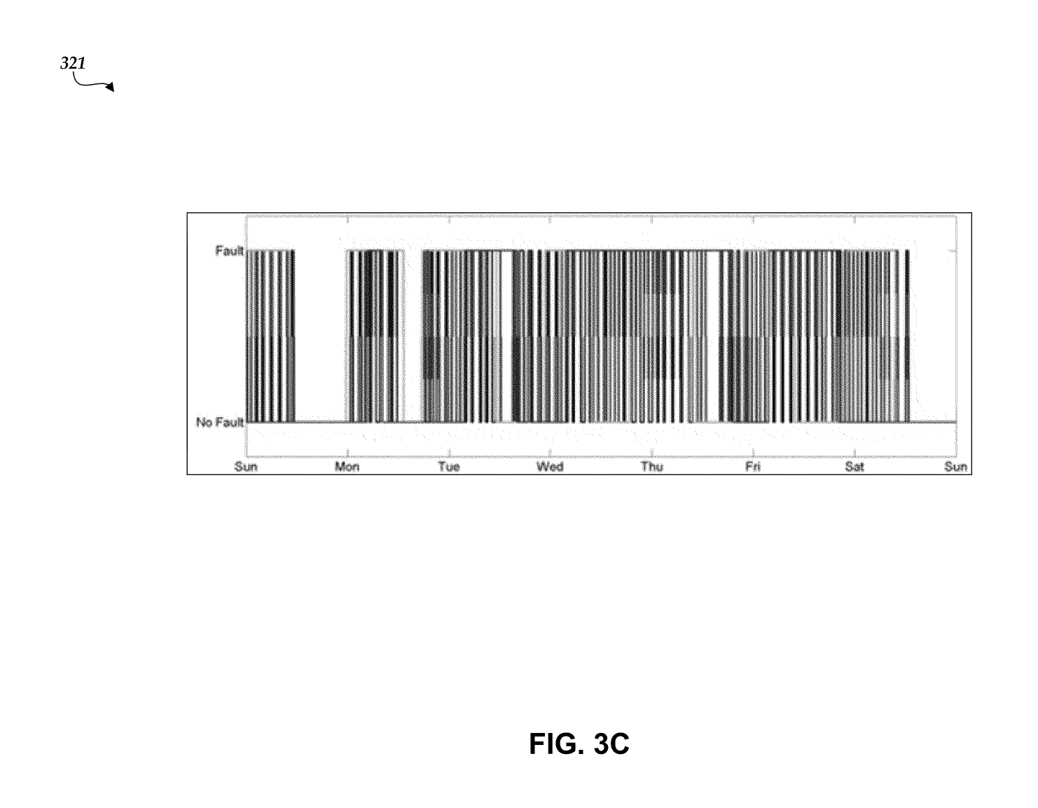

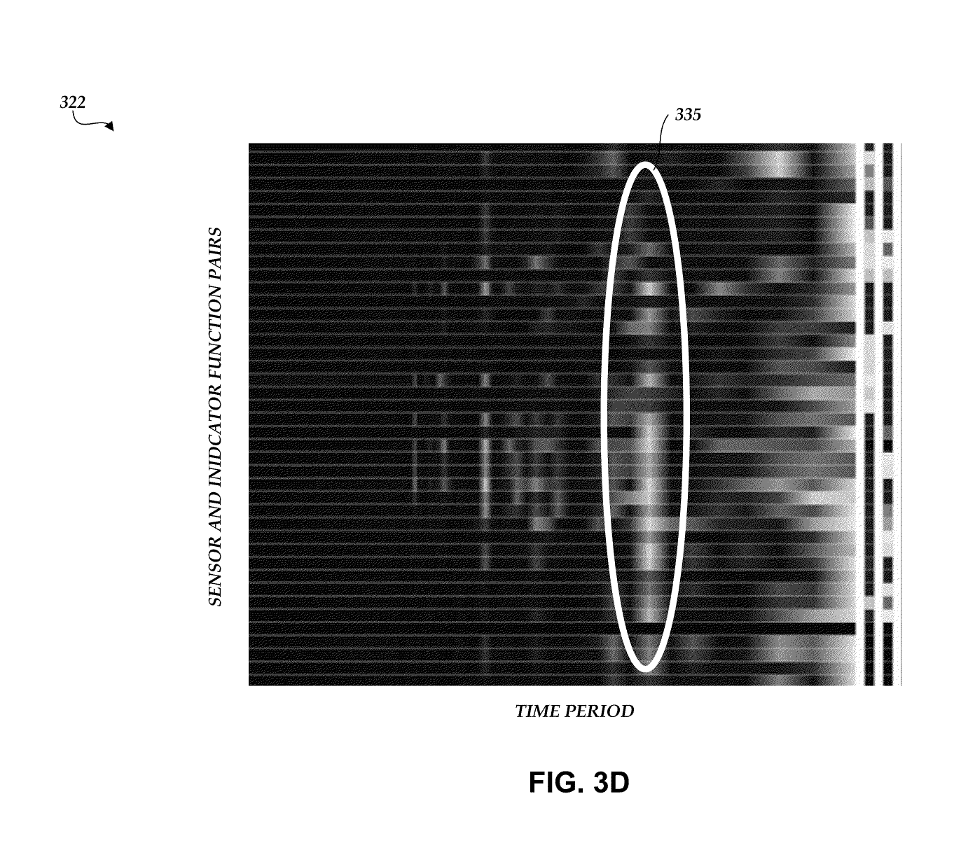

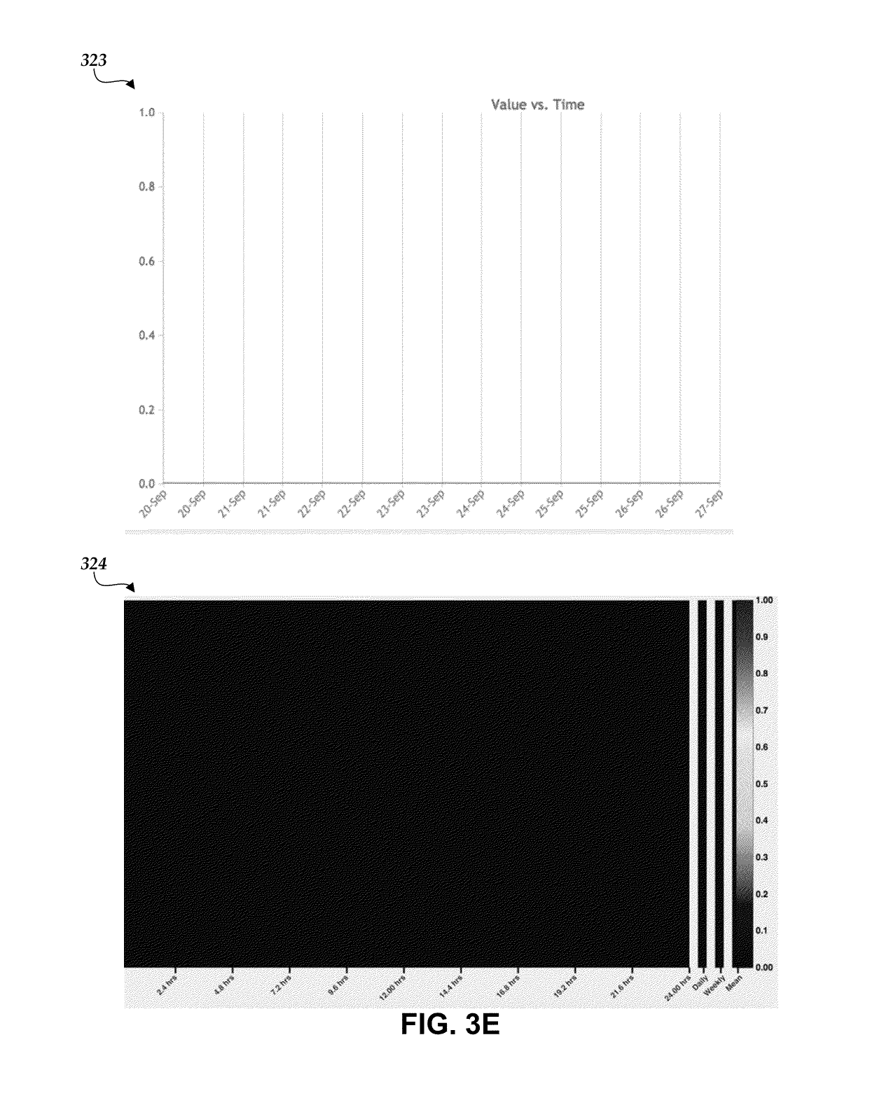

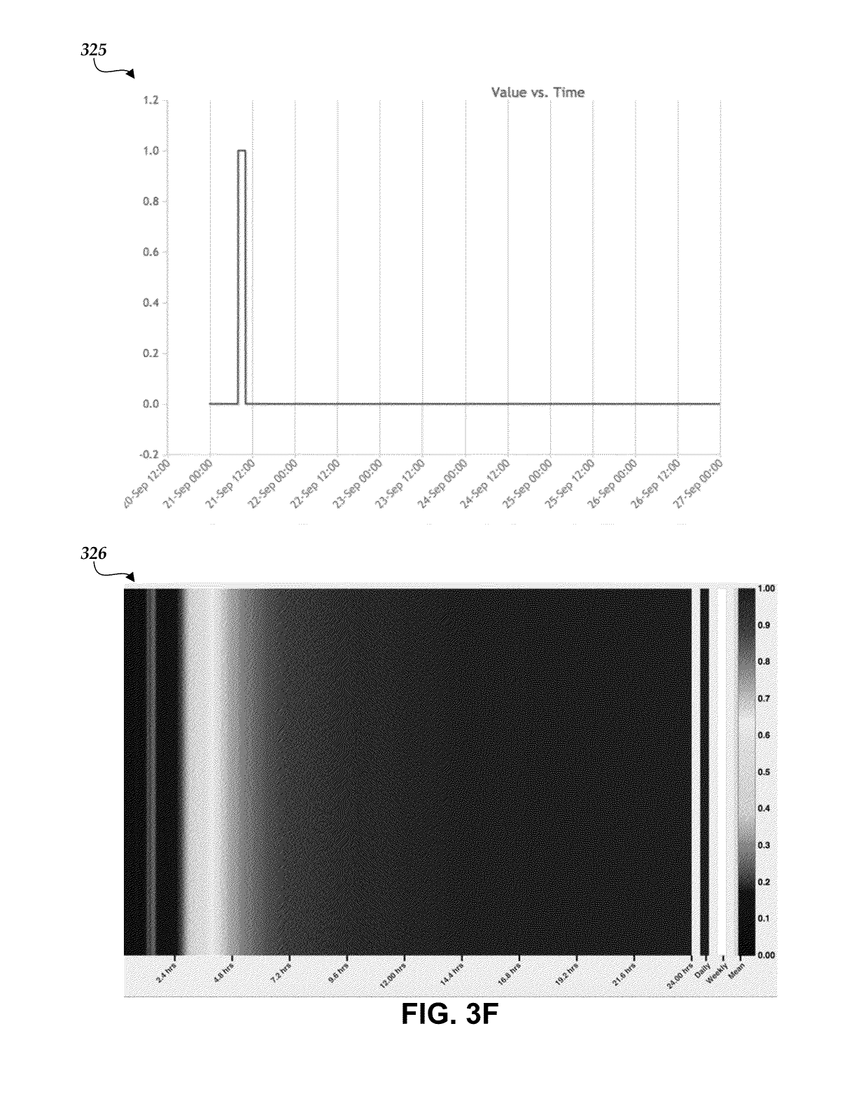

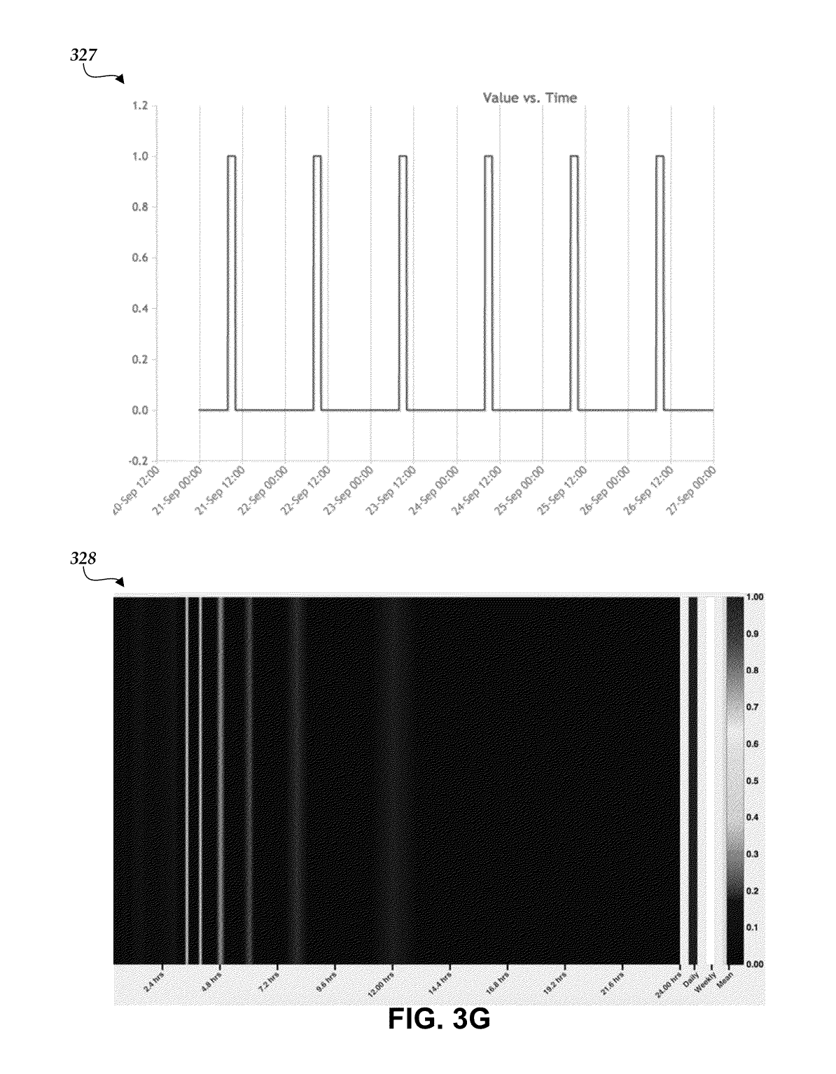

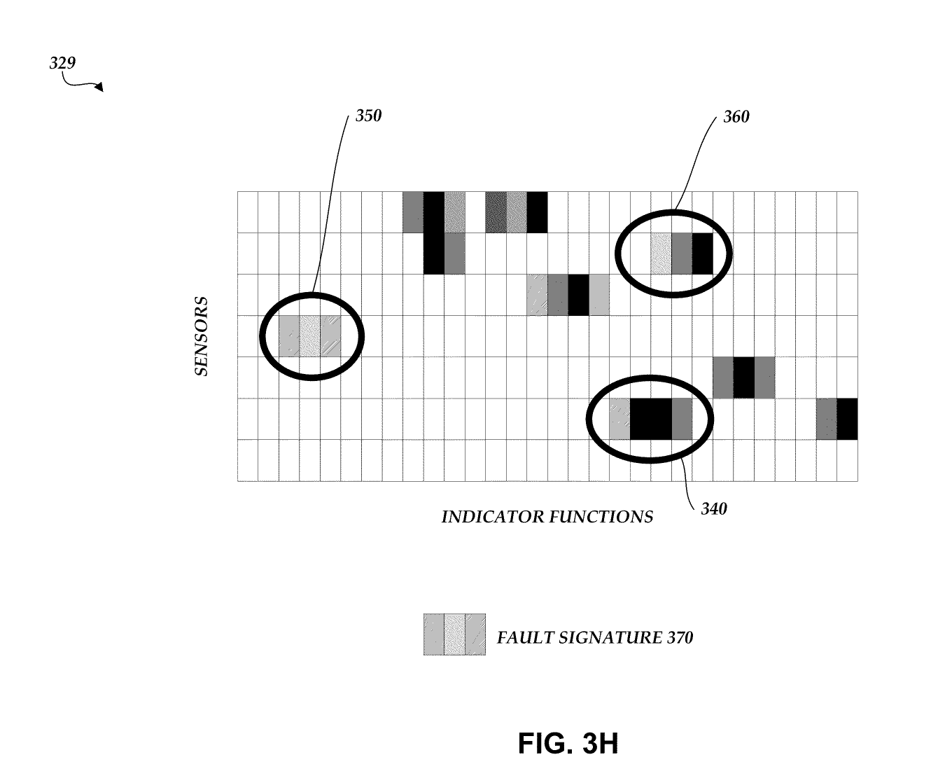

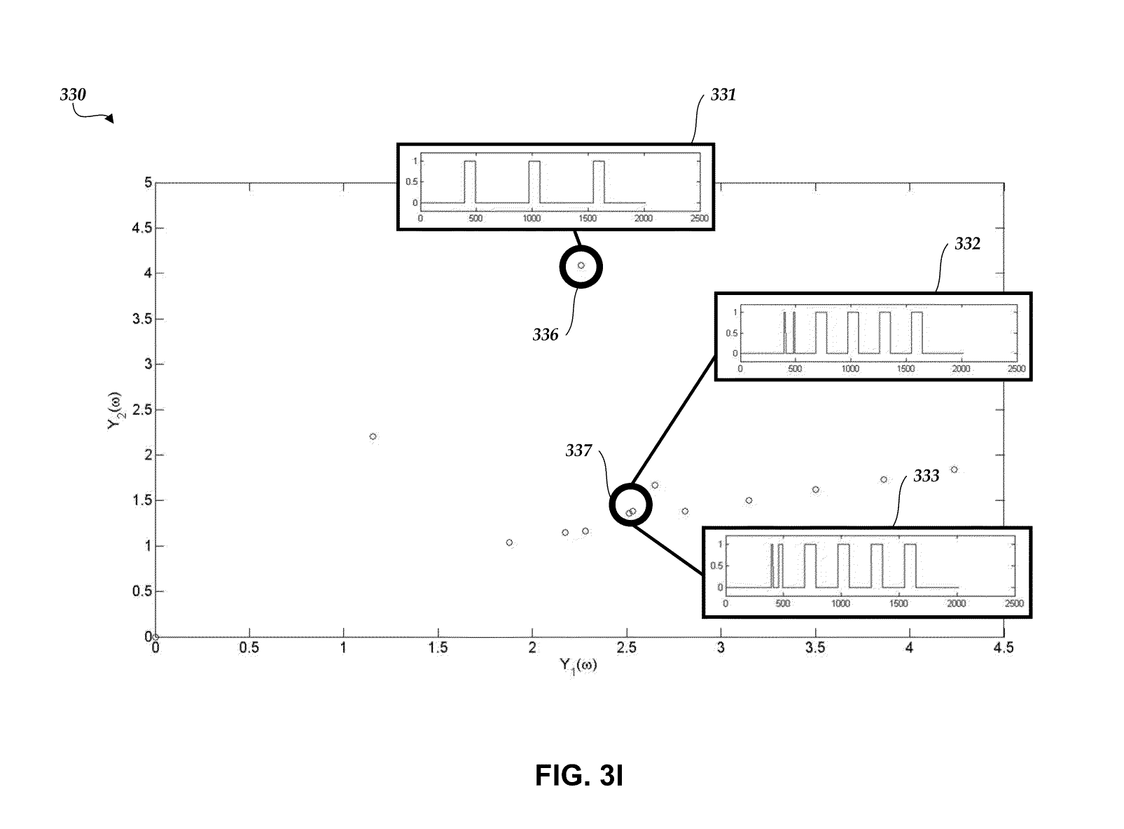

In an embodiment, application of an indicator function to time-series data includes analyzing a data point at each time instance and determining whether the respective data point corresponds to a true condition or a false condition according to the indicator function. For example, if the indicator function defines a true condition to be a value that exceeds a setpoint (e.g., which is undesirable) and a false condition to be a value that does not exceed the setpoint (e.g., which is desirable), then the feature detector 141 analyzes data points at each time instance to determine whether the respective data point exceeds or does not exceed the setpoint. If the data point at a time instance exceeds the setpoint, then the feature detector 141 can assign the time instance to be a high value (e.g., a logical 1). If the data point at a time instance does not exceed the setpoint, then the feature detector 141 can assign the time instance to be a low value (e.g., a logical 0). Thus, the feature detector 141 can generate a new time-series (or an anomalous behavior time-series), where each data point in the new time-series is a high value or a low value. Accordingly, given the example of the first sensor 115 and the second sensor 115 provided above, the feature detector 141 can generate five new time-series, one for each sensor 115 and indicator function pair. Generally, if each data point in the new time-series is a low value, then this may indicate that the sensors 115 or component associated with the new time-series are operating properly. An illustrative example of the application of an indicator function to time-series data is provided in FIG. 3C.

Once the new time-series are generated, the spectral analyzer 142 can perform a spectral analysis (e.g., a Koopman mode analysis using, for example, an Arnoldi subspace method, a discrete Fourier transform, a Burg-type algorithm, etc.) of each of the new time-series to generate a spectral response for each of the new time-series. Performance of the spectral analysis may result in the conversion of the data from the time domain to the frequency domain such that the behavior of the sensors 115 (e.g., whether the data points at different time instances result in a true or false condition) can be described at different time-scales (e.g., in a graph, the x-axis may represent different time periods and a value at each point along the x-axis represents the magnitude (or phase) at the respective time period). For example, if the spectral analysis results in the magnitude (or phase) at a point corresponding to a 24 hour period being high, then this may indicate that data measured by a sensor 115 regularly corresponds to a true condition of an indicator function every 24 hours. An illustrative example of the spectral responses is provided in FIG. 3D.

The fault detector 143 can use the generated spectral responses to detect faults that have possibly occurred. For example, the fault detector 143 can implement clustering techniques (e.g., K-means clustering, hierarchical clustering, etc.) to bin or aggregate the values (e.g., magnitudes, phases, or combinations thereof) of the spectral responses. In an embodiment, the fault detector 143 uses the clustering techniques to bin or aggregate values that correspond to the same sensor 115 or component. In additional embodiments, the fault detector 143 uses the clustering techniques to bin or aggregate values that correspond to different sensors 115 or components. As described above, the spectral responses indicate values for different time-scales. To perform the binning, the fault detector 143 can select a single time-scale and organize into the same row the values associated with the selected time-scale and a single sensor 115 or component, where the order of the values may depend on the implemented clustering techniques (e.g., similar values may be organized together). Thus, each row can include the values derived from the spectral responses associated with a single sensor 115 or component at a selected time-scale (and therefore the values in a row correspond to the different indicator functions associated with the single sensor 115 or component). An illustrative example of the binned values is provided in FIG. 3H.

In an embodiment, once the fault detector 143 bins or aggregates the values, the fault detector 143 scores and/or ranks values based on a level of coincidence (e.g., how similar values are in magnitude, phase, and/or period of occurrence) and/or a level of severity (e.g., the higher the magnitude or phase value, the higher the severity level). For example, as described above, values can be clustered. The fault detector 143 can evaluate clustered values to determine the level of coincidence and/or the level of severity of these clustered values. The higher the level of coincidence and/or the level of severity, the higher such clustered values may be scored. The ranking of clustered values may depend on the score of the clustered values (e.g., the higher the score, the higher the ranking).

The fault detector 143 can use the scored and/or ranked binned values and a set of fault signature to detect potential faults. A fault is an equipment or operational issue (e.g., a malfunction) that adversely affects energy efficiency, occupant comfort, and/or equipment useful life. A fault can be described by a combination of one or more indicator functions. For example, a fault may have occurred if the one or more indicator functions that describe the fault are each high (e.g., correspond to a true condition) at the same time-scale. Because faults can be described using modular indicator functions that can apply to a class of components (e.g., all HVAC systems, regardless of manufacturer), the faults themselves (and the corresponding fault signatures) can apply to a class of components and are not restricted to specific makes and/or models of components or relationships between components that are unique to a particular physical structure 110. As described herein, the modular aspect of the indicator functions also allows the fault detection server 140 (e.g., the fault detector 143) to automatically identify previously unknown faults using a combination of one or more existing indicator functions because the indicator functions may not rely on the physical relationship between components.

In an embodiment, a fault signature is a representation of the fault using scores and/or ranks and the indicator functions associated with the scores and/or ranks. The fault signature can be used to determine the likelihood that a certain fault occurred. For example, a fault signature can be associated with a single indicator function and is defined as a value with a certain score and/or rank or a value within a range of scores and/or ranks. As another example, a fault signature is associated with two or more indicator functions and is defined as a cluster of values with a certain score and/or rank or a cluster of values within a range of scores and/or ranks (e.g., where the cluster of values are associated with the two or more indicator functions, respectively).

The fault signature may correspond with a defined fault description that can be displayed in the interactive user interface when a likely fault is detected. For example, a fault can be that a variable air volume system is providing insufficient cooling capacity. This can result if space temperatures are consistently above a setpoint while a damper remains 100% open. A first indicator function can correspond to a determination of whether the space temperature exceeds the setpoint and a second indicator function can correspond to a determination of whether the damper is open or closed. Both indicator functions may be associated with the same sensor 115 or component. If a variable air volume system is indeed providing insufficient cooling capacity, the spectral response value associated with the first indicator function and the spectral response value associated with the second indicator function may be similar in coincidence and/or severity level during the same time-scale, and thus the values may be clustered together. The fault signature associated with the insufficient cooling capacity of a variable air volume system may then identify the first and second indicator functions and be a score that corresponds to a score that would be expected to be assigned to these clustered values. If the fault signature defines a range of scores, the range may be determined based on a score that would be expected to be assigned to these clustered values and a threshold range above and/or below the expected score.

The fault detector 143 can retrieve the fault signatures from the fault signature data store 147 and compare the retrieved fault signatures with the scored and/or ranked binned values. A comparison yields a proximity of match between a fault signature and the scored and/or ranked binned values if the scored and/or ranked binned values correspond to the same indicator functions that the fault signature is associated with and the scored and/or ranked binned values match the scores and/or ranks or the range of scores and/or ranks defined by the fault signature.

If the scored and/or ranked binned values are proximate to a fault signature (e.g., equal the score and/or rank or fall within a range of scores and/or ranks that define the fault signature), then the fault detector 143 detects that it is likely that a fault corresponding to the fault signature has occurred. The fault detector 143 may determine a probability that the fault occurred based on how close the scored and/or ranked binned value(s) are to the scored and/or ranked value(s) that define the fault signature. The fault detector 143 can transmit a message to the user interface generator 145 such that information regarding the fault can be displayed in an interactive user interface (e.g., a description of the fault and the probability that the fault occurred).

If the scored and/or ranked binned values do not match a fault signature, the fault detector 143 may still detect that a potential fault has occurred. For example, if the coincidence and/or severity level of the clustered values exceed a threshold value but otherwise do not match a fault signature (e.g., equal the score and/or rank or fall within a range of scores and/or ranks that define the fault signature), the fault detector 143 may determine that an unknown fault has potentially occurred. The fault detector 143 can instruct the user interface generator 145 to display information regarding this unknown fault and request user feedback, as described in greater detail below. The fault detector 143 may not, however, determine that an unknown fault has occurred if the indicator function associated with the ranked and/or scored binned values are associated with sensors 115 or components that are not related according to the physical interrelationship information retrieved by the feature detector 141. The fault detector 143 can repeat the binning and fault detection process for other time-scales.

In some embodiments, the fault detector 143 further generates an alert and/or a notification when a likely fault is detected. The alert and/or notification can be automatically transmitted by the fault generator 143 to the user device 160 to inform a user associated with the alert and/or notification. The alert and/or notification can be transmitted at the time that the alert and/or notification is generated or at some determined time after generation of the alert and/or notification. When received by the user device 160, the alert and/or notification can cause the user device 160 to display the alert and/or notification via the activation of an application on the user device 160 (e.g., a browser, a mobile application, etc.). For example, receipt of the alert and/or notification may automatically activate an application on the user device 160, such as a messaging application (e.g., SMS or MMS messaging application), a standalone application (e.g., fault detection application), or a browser, for example, and display information included in the alert and/or notification. If the user device 160 is offline when the alert and/or notification is transmitted, the application may be automatically activated when the user device 160 is online such that the alert and/or notification is displayed. As another example, receipt of the alert and/or notification may cause a browser to open and be redirected to a login page generated by the fault detection server 140 so that the entity can log in to the fault detection server 140 and view the alert and/or notification. Alternatively, the alert and/or notification may include a URL of a webpage (or other online information) associated with the alert and/or notification, such that when the user device 160 (e.g., a mobile device) receives the alert, a browser (or other application) is automatically activated and the URL included in the alert and/or notification is accessed via the Internet.

The machine learning feedback system 144 can use heuristics (e.g., artificial intelligence, such as machine learning, support vector regression, support vector machines, ensemble methods, artificial neural networks, diffusion maps, etc.) to modify operation of the fault detector 143 over time based on user feedback. In an embodiment, the interactive user interface that displays detected faults to a user also provides the user with an opportunity to confirm that a fault occurred or indicate that a detected fault is a false positive (or otherwise unimportant to the user). For example, an operator of a first physical structure 110 may not be interested in faults that are detected as occurring on 24 hour periods. Thus, the operator may close faults detected as occurring on 24 hour periods. The machine learning feedback system 144 can use this information to modify the operation of the fault detector 143 such that the fault detector 143 reduces or eliminates the flagging of incidents that occur on 24 hour periods as being potential faults. As another example, the fault detector 143 may identify an unknown fault and information of the unknown fault may be presented to an operator of a second physical structure 110. If the operator confirms that a fault occurred (and provides additional descriptive information of the fault), then the machine learning feedback system 144 can generate a new fault signature for storage in the fault signature data store 147. The new fault signature can be based on the score(s) of the value or clustered values that triggered the previously unknown fault. Thus, the next time the fault detector 143 begins searching for faults, the fault detector 143 can use the new fault signature when performing the comparisons. As mentioned previously, if the scored and/or ranked binned values are proximate to a fault signature, then the fault detector 143 can detect that a fault corresponding to the fault signature has occurred. Based on whether the operator acts (or does not act) on a reported fault and/or based on any feedback provided by the operator regarding a reported fault (e.g., feedback such as whether the reported fault is actually a fault), the machine learning feedback system 144 can modify one or more fault signatures so that future scored and/or ranked binned values better align with the reporting preferences of the operator.

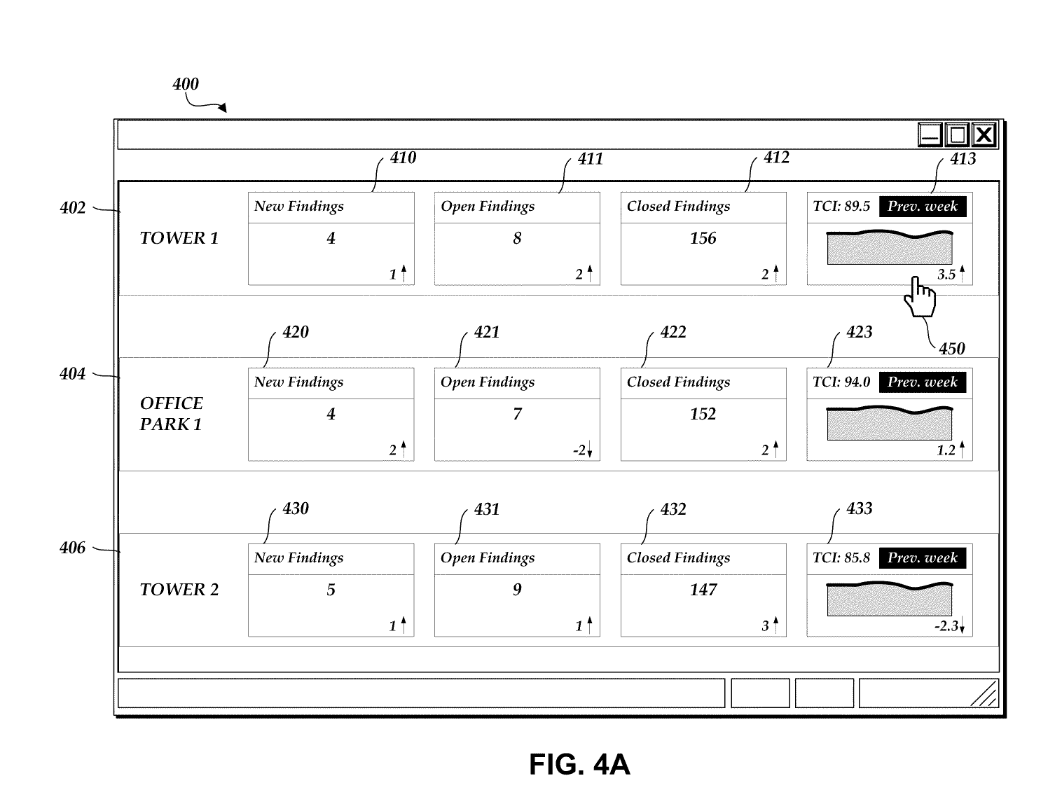

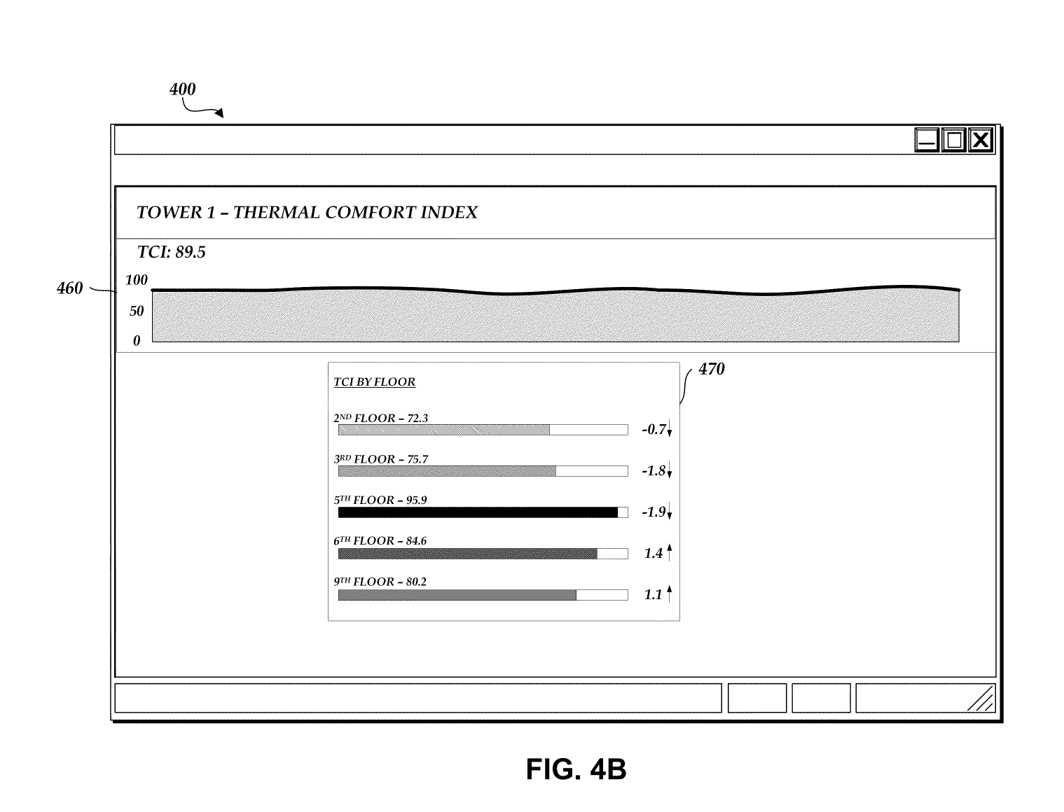

The user interface generator 146 may generate an interactive user interface that provides a summary of one or more physical structures 110, displays a description of the detected faults, displays or indicates a probability that the detected fault occurred, and provides an opportunity for a user to provide feedback on whether a detected fault can be confirmed as an actual fault. The interactive user interface may provide additional features, such as the ability to correct or address a fault, add notes associated with a fault, and other information related to the fault. Example interactive user interfaces are described in greater detail below with respect to FIGS. 4A-6.

The indicator function data store 146 can store indicator functions that are each associated with a sensor 115 or class of component. As described herein, the indicator functions may not be constructed in a manner such that the indicator functions correspond to a specific component in a class of components. While the indicator function data store 146 is illustrated as being stored in the fault detection server 140, this is not meant to be limiting. The indicator function data store 146 can be external to the fault detection server 140.

The fault signature data store 147 can store a plurality of fault signatures. The fault signature data store 147 can be updated with new fault signatures generated by the machine learning feedback system 144. While the fault signature data store 147 is illustrated as being stored in the fault detection server 140, this is not meant to be limiting. The fault signature data store 147 can be external to the fault detection server 140.

The hierarchical data store 148 can store the physical relationships between sensors and/or components. While the hierarchical data store 148 is illustrated as being stored in the fault detection server 140, this is not meant to be limiting. The hierarchical data store 148 can be external to the fault detection server 140.

The mapping data store 149 can store the mapping of the provided information on the components within the physical structure 110 into the standard format. While the mapping data store 149 is illustrated as being stored in the fault detection server 140, this is not meant to be limiting. The mapping data store 149 can be external to the fault detection server 140.

In an embodiment, the fault detection server 140 begins the fault detection process when data is received from the sensors 115 and/or the sensor data store 150. In other embodiments, the fault detection server 140 beings the fault detection process at set intervals or at random times.

The operations described herein with respect to the fault detection server 140 can improve the processing efficiency and memory utilization over other systems that may attempt to identify faults in physical structures 110. For example, typical systems identify faults based on an analysis of data in the time domain. The sensors 115 can measure data at hundreds to thousands of times a second, resulting in a large amount of data to process and analyze, thereby affecting the performance of these typical systems. However, by converting the data from the time domain to the frequency domain (and then binning, scoring, and/or ranking the data), the amount of data that is eventually processed by the fault detector 143 to identify faults is significantly reduced. For example, instead of having tens of thousands of data points to cover a 24 hour period for one sensor 115 to identify a potential fault, the fault detection server 140 can filter the data to a single set of values for a 24 hour period and sensor 115 (e.g., a single data point for each indicator function associated with the sensor 115, as described and illustrated herein and below with respect to FIG. 3H). Accordingly, the operations described herein provide significant improvements to the functioning of the fault detection server 140, reducing memory utilization and increasing processor performance through the reduction in the amount of data that needs to be stored and processed.

The fault detection server 140 may be implemented as a special-purpose computer system having logical elements. In an embodiment, the logical elements may comprise program instructions recorded on one or more machine-readable storage media. Alternatively, the logical elements may be implemented in hardware, firmware, or a combination thereof. In one embodiment, the fault detection server 140 may be implemented in a Java Virtual Machine (JVM) that is executing in a distributed or non-distributed computer system. In other embodiments, the fault detection server 140 may be implemented as a combination of programming instructions written in any programming language (e.g. C++, Visual Basic, Python, etc.) and hardware components (e.g., memory, CPU time) that have been allocated for executing the program instructions.

A user may use the user device 160 to view and interact with the interactive user interface generated by the user interface generator 145. For example, the user device 160 may be in communication with the fault detection server 140 via the network 120. The user device 160 can include a wide variety of computing devices, including personal computing devices, terminal computing devices, laptop computing devices, tablet computing devices, electronic reader devices, mobile devices (e.g., mobile phones, media players, handheld gaming devices, etc.), wearable devices with network access and program execution capabilities (e.g., “smart watches” or “smart eyewear”), wireless devices, set-top boxes, gaming consoles, entertainment systems, televisions with network access and program execution capabilities (e.g., “smart TVs”), and various other electronic devices and appliances. The user devices 160 may execute a browser application to communicate with the fault detection server 140.

In an embodiment, the network 120 includes any communications network, such as the Internet. The network 120 may be a wired network, a wireless network, or a combination of the two. For example, network 120 may be a local area network (LAN) and/or a wireless area network (WAN).

### Example to Illustrate Concepts Implemented by the Fault Detection Server 140

To understand why the operations described herein are implemented to detect faults, an explanation of the underlying concepts that drive the operation of the fault detection server 140 may be useful. In particular, the following paragraphs in this section describe conceptually how the fault detection server 140 identifies known faults and new, previously unknown faults.

As described herein, the fault detection server 140 can detect and/or classify faults from time-series data using, in part, a spectral analysis (e.g., spectral Koopman methods) combined and a cluster analysis. The fault detection server 140 can take measured data and analyze the time-series behavior between the difference of outputs and their expected value. For example, using spectral Koopman methods, the fault detection server 140 can represent the result in the frequency domain to characterize the time-scales at which measured data is not behaving as anticipated. Using the frequency domain representation, the fault detection server can define spectral signatures of faults (e.g., which correspond to the scores and/or ranks described herein), and these signatures can be compared with the signature of the deviation of measured data from the expectation.

In an embodiment, let the following equation:

g(t)=g₁(t), . . . ,gₙ(t)) (1)

be a vector input of measured functions of time (g₁(t), . . . gₙ(t)). From g(t), the vector of outputs can be defined as follows:

y(t)=η(g(t)) (2)

where η is a mapping of the measured functions of time to some output space. Let the following equation:

f(t)=(f₁(t), . . . ,fₘ(t)) (3)

be a vector input of predefined functions of time. In the detection of faults, there may be some desired, or expected, behavior of these time-series signals. From f(t), the vector of desired or expected outputs can be defined as follows:

y_{E}(t)=κ_{E}(f(t)) (4)

where κ_{E} can be a mapping of the functions of time to some expected values. For example, if f(t) is the output of an indicator function, then κ_{E}(f(t)) is a vector of zeros (e.g., no anomalous behavior is detected). In a more advanced example, if f(t) is a time-series of temperature measurements, then κ_{E}(f(t)) may be the deviation from a setpoint or the ideal temperature response as predicted from, for example, a building energy model. Thus, the desired or expected output can be a composition of the vector function κ_{E} with functions of time f(t)=(f₁(0, . . . , fₙ(t)). A function of particular interest may be the Koopman spectrum corresponding to the subtraction function y(t)−yₑ(t). This spectrum of the subtraction function can be represented as Y(ω), which can be a complex value. An example of the spectral response of the time-series obtained by taking the difference between an output and its expected value is illustrated in FIG. 3D.

In an ideal operating scenario (e.g., no fault has occurred), the magnitude of the entire spectrum would be equal to zero (e.g., Y(ω)=0 for all ω), indicating that y(t) equals yₑ(t) or that the observed output is equal to its expected value for all time. Spectral responses that have nonzero magnitudes can indicate some deviation from the expected behavior of the output. Based on the magnitude of other spectral signatures, these deviations from zero can designate the existence of a fault.

The concept of the Koopman spectrum can be used here to capture as broad a class of dynamical behaviors of components as possible. For example, the signals can be nonlinear, and thus the concept of the linear state-space representation spectrum may not be applicable, and the signals may not be periodic (e.g., so this is not necessarily the Fourier spectrum). The concept of Koopman spectrum can be reduced to linear spectrum when, for example, the dynamics are linear and can be reduced to Fourier spectrum when, for example, the dynamics are periodic.

In an embodiment, because a scenario in which there are no faults can be defined as Y(ω) equals 0 for all ω, any state or scenario where Y(ω) does not equal 0 can indicate some form of adversity within one or more sensors 115 or components of the physical structure 110 and can be considered a fault. However, there are such state that are more important than others, and classification and artificial intelligence (e.g., machine learning) can be used to identify which are important and which are not. For example, among Y(ω) that does not equal 0, specific faults corresponding to understood physical issues can be defined and labeled as Fᵢ (e.g., where Fᵢ corresponds to a physical description or is an indicator of a known condition, such as “temperature above a setpoint”), where i equals values from 1 to m, thereby corresponding to different Y_{Fi}(ω). Thus, faulty states can be classified by their distance from Y(ω) equals 0 and Y_{Fi}(ω). The fault detection server 140 can use clustering techniques to assign a particular observed Y(ω) to a specific fault Fᵢ. In addition, if a cluster of points close to Y_{D}((ω)) does not equal 0 is observed in Y space that does not correspond to any specific, known Y_{Fi}(ω), then this could potentially be identified by the fault detection server 140 as a previously unknown fault. The fault detection server 140 can include the previously unknown fault in the interactive user interface and request that the user confirm that the detected fault is indeed a fault and/or to provide a physical description of the detected fault (e.g., a description of the malfunction that has occurred). This new fault D can then be mapped to F_{M+1} (e.g., added to the fault signature data store 147 as a new fault signature).

In a further embodiment, Y(ω) can be reduced to a scalar value. For example, the fault detection server 140 can perform this reduction through a scoring process (such as the scoring process described herein) that evaluates Y(ω) and assigns a value according to characteristics of the spectrum, where high values indicate persistent deviations from desired behavior and low values signify that an output (e.g., sensor 115 or component) is behaving as expected. The result can be a binning map, such as the depicted in the graph 329 in FIG. 3H. The binning process facilitates analysis by taking high-dimensional data (e.g., the spectrum of Y(ω), the spectrum of a classified fault Fᵢ, or in general, the spectrum generated by any time-series) and embedding the high-dimensional data into a lower dimensional manifold. This binning process then provides additional means of grouping subtraction function(s), Y(ω), to a fault, Fᵢ, based on the proximity of characteristics of the spectrum between both quantities and the attributes of the particular binning process being used. Some methods of binning (e.g., dimensionality reduction) include self-organizing maps (SOM), diffusion maps, K-means clustering, density-based clustering, and/or the like.

### Example Fault Detection Flow and Illustrative Graphs

FIG. 3A illustrates a flow diagram 300 illustrating the operations performed by the fault detection server 140. FIGS. 3B-3I depict graphs 320-330 that graphically represent the operations performed by the fault detection server 140. In some embodiments, the fault detection server 140 performs the operations described herein, but does not generate graphical representations of these operations. In other embodiments, the fault detection server 140 generates the graphical representations of these operations and displays one or more of the graphs 320-330 in the interactive user interface generated by the user interface generator 145.

As illustrated in FIG. 3A, sensor data 302A-N can be received from various sensors 115. The sensor data 302A-N can be time-series data, as illustrated in the graph 320 in FIG. 3B. In the example of FIG. 3B, the sensor data 302A-N includes temperature values over time. While a user may notice that the sensor data 302A-N generally oscillates within a range of temperatures, it may be very difficult for the user to identify any trends or faults from just a visual inspect of the sensor data 302A-N.

In an embodiment, an indicator function 304A is applied to the sensor data 302A, an indicator function 304B is applied to the sensor data 302B, and so on. While a single indicator function is depicted in FIG. 3A as being applied to a given sensor data 302A-N, this is merely for illustrative purposes and is not meant to be limiting. Any number of indicator functions can be applied to the same sensor data 302A-N. The graph 321 in FIG. 3C illustrates an example anomalous behavior time-series generated by the fault detection server 140 (e.g., the feature detector 141) in response to application of an indicator function 304A-N to one of the sensor data 302A-N. As depicted in the graph 321, the time-series has a high value corresponding to a true condition (e.g., a determination that anomalous behavior has occurred) at various time instances in which a condition defined by the indicator function 304A-N is satisfied and a low value corresponding to a false condition (e.g., a determination that no anomalous behavior has occurred) at various time instances in which a condition defined by the indicator function 304A-N is not satisfied.

The fault detection server 140 (e.g., the feature detector 141 or the spectral analyzer 142) may perform a multiplex 306 operation on the various anomalous behavior time-series that are generated (e.g., N anomalous behavior time-series are generated in this example). For example, the fault detection server 140 may aggregate the various anomalous behavior time-series.

The fault detection server 140 (e.g., the spectral analyzer 142) can then perform a spectral analysis 308 on the aggregated anomalous behavior time-series to convert the data from the time domain to the frequency domain and generate spectral responses for each of the time-series. The graph 322 in FIG. 3D represents the data in the frequency domain. Each row in the graph 322 may correspond to a different sensor and indicator function pair and a shading of the graph 322 at a particular row and time period may represent a magnitude value (or a phase value or a combination of magnitude and phase values). For example, a lighter the shading (or a darker the shading), the higher the magnitude (or phase) value is. As depicted in the graph 322, many of the sensor and indicator function pairs have a high magnitude (or phase) value near the time period highlighted by marker 335. In alternative embodiments, the fault detection server 140 can perform the multiplex 306 operation after the spectral analysis 308 operation.

The spectral response of an anomalous behavior time-series can depend on the anomalous behavior time-series data itself. For example, FIGS. 3E-3G depict the spectral responses for different types of anomalous behavior time-series. As illustrated in FIG. 3E, the graph 323 depicts an anomalous behavior time-series in which no anomalous behavior is detected (e.g., no fault occurred). The graph 324 depicts the spectral response of such an anomalous behavior time-series (e.g., the spectral response has a uniformly low magnitude and/or phase). As illustrated in FIG. 3F, the graph 325 depicts an anomalous behavior time-series in which non-recurrent anomalous behavior is detected (e.g., a one-time fault occurred). The graph 326 depicts the spectral response of such an anomalous behavior time-series. As illustrated in FIG. 3G, the graph 327 depicts an anomalous behavior time-series in which recurrent anomalous behavior is detected (e.g., a recurring fault occurred). The graph 328 depicts the spectral response of such an anomalous behavior time-series.

The fault detection server 140 (e.g., the fault detector 143) can then bin 310 the spectral responses at a selected time period using clustering techniques. For example, a 24 hour time period can be selected (or a weekly time period, a seasonal time period, an annual time period, etc.), and the magnitudes associated with the sensor and indicator function pairs can be reorganized by sensor and indicator function, as depicted in the graph 329 in FIG. 3H. The binning 310, scoring, ranking, and fault signature comparisons is described herein with respect to magnitude values, but this is merely for illustrative purposes and is not meant to be limiting. The binning 310, scoring, ranking, and fault signature comparisons can also be performed using phase values from the spectral response or combinations of magnitude values and phase values from the spectral response. Each row in the graph 329 may correspond to a sensor (or component) and each column in the graph 329 may correspond to an indicator function. Alternatively, the rows and columns can be flipped. A tile can be shaded based on the magnitude of the value associated with the sensor and indicator function pair. In some embodiments, a darker color represents a higher magnitude and a lighter color represents a lower magnitude (or vice-versa).

In addition to the binning 310, the fault detection server 140 can score and/or rank the magnitude values associated with the sensor and indicator function pair based on the level of coincidence and/or severity of clusters of magnitude values. For example, cluster 340 includes magnitude values corresponding to the same sensor that have similar magnitudes (e.g., a high level of coincidence) and similarly high magnitudes (e.g., a high level of severity). Thus, the cluster 340 may receive a high score and/or rank. Likewise, cluster 350 also includes magnitude values corresponding to the same sensor that have similar magnitudes (e.g., a high level of coincidence), but relatively low magnitudes (e.g., a low level of severity). Thus, the cluster 350 may receive a lower score and/or rank than the cluster 340. Cluster 360 includes magnitude values corresponding to the same sensor that do not have similar magnitudes (e.g., a low level of coincidence), and relatively average magnitudes (e.g., a medium level of severity). Thus, the cluster 360 may receive a lower score and/or rank than the cluster 340 and/or the cluster 350. In some embodiments, the tiles are re-shaded to correspond to the determined score and/or rank.

The binning can help the fault detection server 140 identify possible faults because similar time-series data may correspond to points in spectral coordinates that are near each other. Thus, if anomalous behavior time-series data that is known to correspond to a fault is similar to recently analyzed anomalous behavior time-series data (and thus a fault may have occurred), then an analysis of the proximity of the spectral responses of the two time-series can be an appropriate technique implemented by the fault detection server 140 to determine that a fault is detected and what the probability that the fault actually occurred is. For example, graph 330 in FIG. 3I depicts points in a spectral space that correspond to binned values. As illustrated in FIG. 3I, one point is marked by marker 336 and a cluster of two points are marked by marker 337, where the point marked by marker 336 and the two points marked by marker 337 are some distance apart. Graph 331 illustrates a time-series associated with the point marked by the marker 336, graph 332 illustrates a time-series associated with one of the points marked by the marker 337, and graph 333 illustrates a time-series associated with the other point marked by the marker 337. Because the two points marked by marker 337 are near each other, the graphs 332 and 333 are very similar. However, because the point marked by marker 336 is far from the other two points, the graph 331 is different from the graphs 332 and 333.

Once the binning 310 is complete, the fault detection server 140 can detect faults 312 that may have occurred by comparing the scores and/or ranks and the indicator function(s) associated with the scores and/or ranks with various fault signatures. Alternatively, the fault signatures can be described as magnitude values and associated indicator function(s), and the fault detection server 140 can detect faults 312 by comparing the magnitude values (e.g., as illustrated in the graph 329) with the fault signatures to identify matches. For example, FIG. 3H illustrates a sample fault signature 370. The magnitude of the first tile of the fault signature 370 matches the magnitude of the first tile in the cluster 350, the magnitude of the second tile of the fault signature 370 matches the magnitude of the second tile in the cluster 350, and the magnitude of the third tile of the fault signature 370 matches the magnitude of the third tile in the cluster 350. If the first tile in the cluster 350 and the first tile in the fault signature 370 correspond to the same indicator function, if the second tile in the cluster 350 and the second tile in the fault signature 370 correspond to the same indicator function, and/or if the third tile in the cluster 350 and the third tile in the fault signature 370 correspond to the same indicator function, then the fault detection server 140 may determine that a fault has likely occurred, the probability that the fault occurred (e.g., which is based on close the score, rank, and/or magnitude of a tile is to the corresponding tile in the fault signature 370), and that the fault is associated with the sensor (or component) corresponding to the cluster 350. Information on detected faults (e.g., a description, probability that the fault occurred, etc.) can be displayed in the interactive user interface. While the magnitudes of the tiles in the fault signature 370 do not match the magnitudes of the tiles in the clusters 340 and 360, the fault detection server 140 may nonetheless determine that a fault has likely occurred if the magnitudes fall within a range of magnitudes defied by the fault signature 370 or that a fault has potentially occurred if the machine learning indicates that the magnitudes correspond to behavior associated with faults.

### Example Physical Structure Summaries in an Interactive User Interface

FIGS. 4A-4B illustrate a user interface 400 displaying a physical structure 110 summary information for a plurality of physical structures 110. In an embodiment, the user interface 400 is generated by the user interface generator 145. The summary information displayed in the user interface 400 can be derived from the sensor data stored in the sensor data store 150 and/or retrieved from the sensors 115 of various physical structures 110. For example, as illustrated in FIG. 4A, the user interface 400 can display summary information for Tower 1, Office Park 1, and Tower 2.

Information for Tower 1 can be displayed in window 402. The window 402 includes four sub-windows 410-413, where window 410 depicts new findings related to Tower 1 (e.g., new detected faults) and an increase or decrease in new findings over a period of time, window 411 depicts open findings related to Tower 1 (e.g., faults that have been viewed, but not addressed) and an increase or decrease in open findings over a period of time, window 412 depicts closed findings related to Tower 1 (e.g., faults that have been addressed) and an increase or decrease in closed findings over a period of time, and window 413 depicts a key performance index (KPI), such as thermal comfort index (TCI). For example, TCI for Tower 1 is depicted over the indicated period of time (e.g., the previous week in this example) and an increase or decrease in the TCI over that time period. The TCI can represent a percentage of time that the temperature of a room or physical structure 110 is within a defined comfort range. For example, the TCI can be a number of temperature records within a temperature range (e.g., 70-76 degrees Fahrenheit) over all temperature records (e.g., temperature records gathered when the locations are occupied). Other KPIs may also be depicted as they relate to energy efficiency, occupant comfort, equipment useful life, and/or the like.

Likewise, information for Office Park 1 can be displayed in window 404 and information for Tower 2 can be displayed in window 406. Sub-windows 420 and 430 correspond to the type of information depicted in sub-window 410, sub-windows 421 and 431 correspond to the type of information depicted in sub-window 411, sub-windows 422 and 432 correspond to the type of information depicted in sub-window 412, and sub-windows 423 and 433 correspond to the type of information depicted in sub-window 413.

In an embodiment, a user can select any of the windows or sub-windows to view additional information. For example, the user can select the sub-window 413 via cursor 450 to view more information about the KPI. Selection of the sub-window 413 causes the user interface 400 to display a graph 460 depicting the KPI over time and a table 470 depicting the KPI by floor in Tower 1, as illustrated in FIG. 4B. The table 470 can include a numerical value representing a current KPI for a given floor, a shaded graph visually representing the current KPI for a given floor (e.g., where the darker the shade, the higher the KPI), and a change in KPI over a time period for a given floor.

### Example Display of Detected Faults in an Interactive User Interface

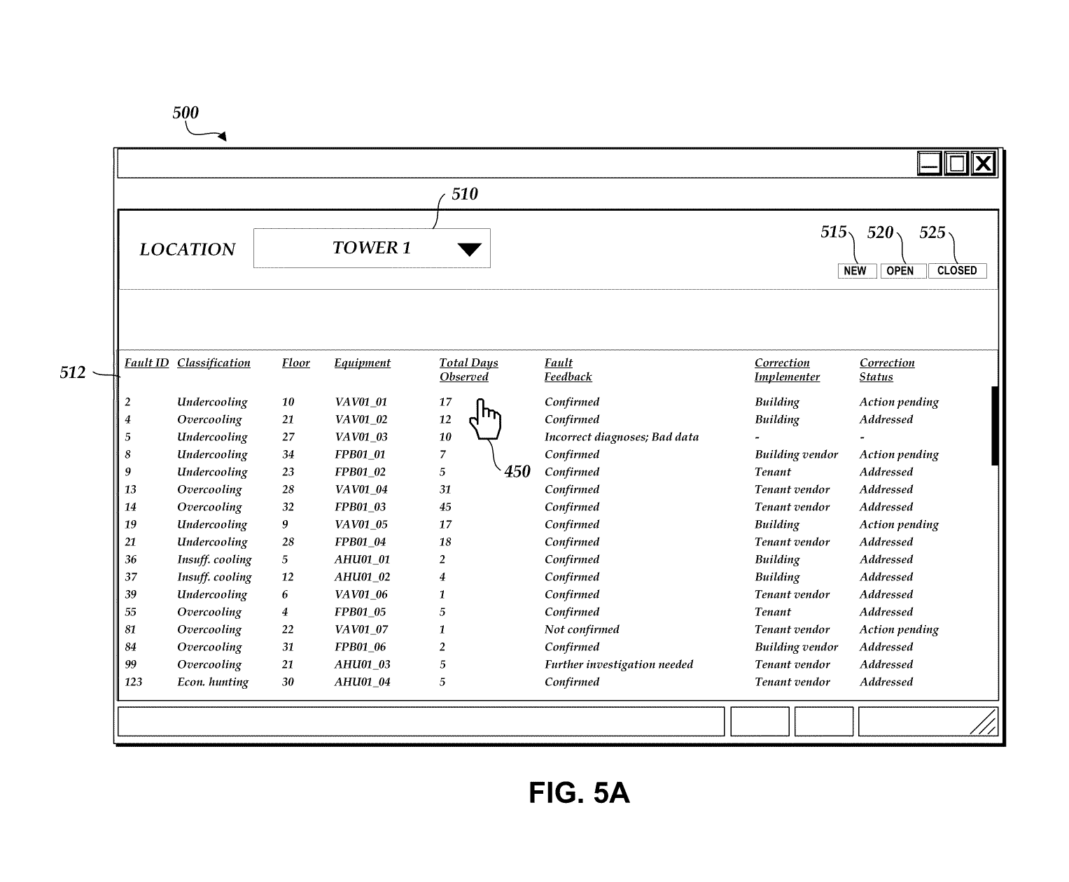

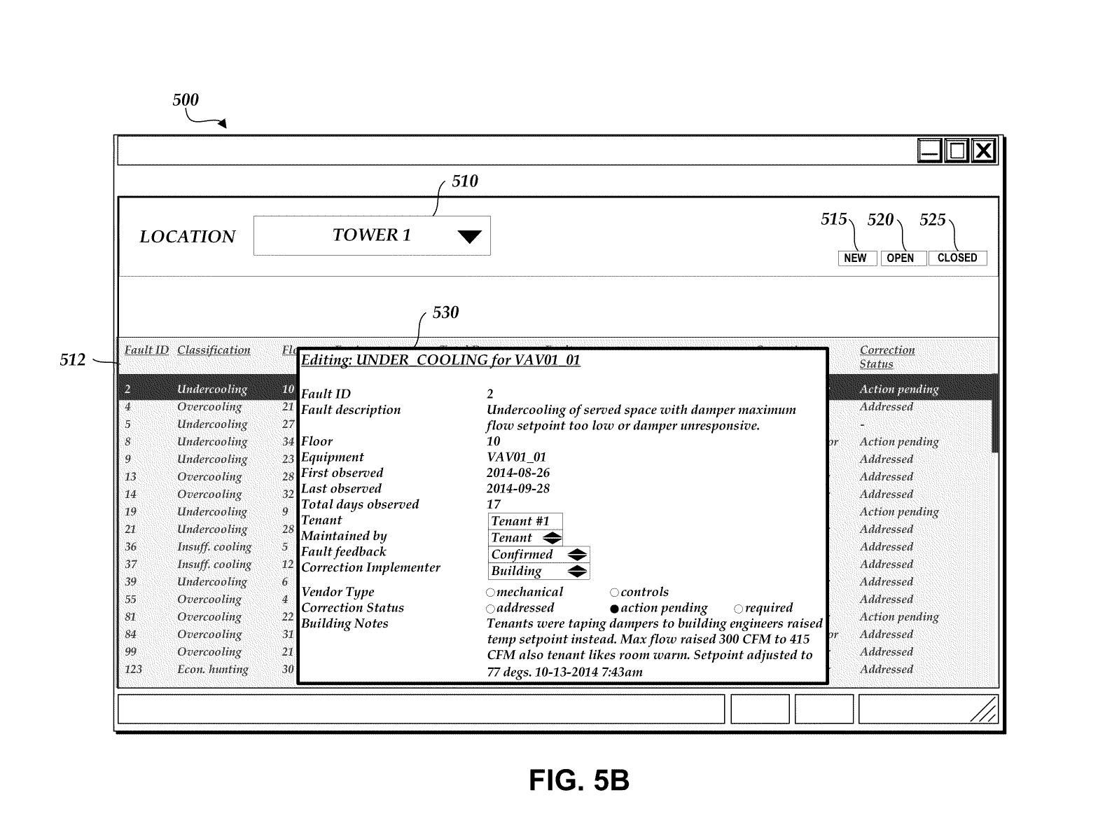

FIGS. 5A-5B illustrate a user interface 500 displaying the faults detected for a physical structure 110. In an embodiment, the user interface 500 is generated by the user interface generator 145. A user can cause the user interface 500 to be displayed by, for example, selecting windows 402, 404, and/or 406 in the user interface 400.

As illustrated in FIG. 5A, the user interface 500 displays an identification of the physical structure 110 in field 510 (e.g., Tower 1 in this case), a table 512 displaying fault information, a new button 515, an open button 520, and a closed button 525. Each row in the table 512 can correspond to a fault. Each row can identify a fault ID, a classification of the fault (e.g., undercooling, overcooling, economizer hunting, etc.), a floor in Tower 1 in which the fault occurred, a specific equipment associated with the fault (e.g., a specific variable air volume system, fan powered box, air handling unit, HVAC system, etc.), a number of days during which the fault is observed, a fault feedback provided by the user (e.g., the fault is confirmed as a fault, the fault is not confirmed, the fault is incorrectly diagnosed as a fault, further investigation is needed, etc.), an identification of the correction implementer (e.g., a building, a tenant, a building vendor, a tenant vendor, that a fault cannot be addressed cost-effectively for a given reason, etc.), and a correction status (e.g., action pending, addressed, required, etc.).

The buttons 515, 520, and 525 can be used as filters. For example, selection of the new button 515 can cause the user interface 500 to only display new faults in the table 512. A fault may be categorized as new until a user indicates that the fault has been addressed and/or until a threshold period of time elapses. Likewise, selection of the open button 520 can cause the user interface 500 to only display open faults in the table 512 and selection of the closed button 525 can cause the user interface 500 to only display closed faults in the table 512. A fault may be categorized as closed if a user has indicated that the fault has been addressed and the fault has not been observed by the fault detection server 140 in any analysis period a threshold amount of time after the user indicates that the fault is addressed. In additional embodiments, selection of sub-window 410 can result in the user interface 500 displaying the same information as the selection of the new button 515, selection of sub-window 411 can result in the user interface 500 displaying the same information as the selection of the open button 520, and selection of sub-window 412 can result in the user interface 500 displaying the same information as the selection of the closed button 525.

In an embodiment, any of the rows of the table 512 can be selected to view additional information regarding the chosen fault. For example, the user can select the fault identified with the ID of 2 via the cursor 450. Selection of this row causes the user interface 500 to display a window 530 that displays more information about the fault, as illustrated in FIG. 5B. The window 530 includes some of the same information as provided in the table 512, as well as a detailed description of the fault, a date first observed, a date last observed, a time to address a fault, and an option to enter notes and/or view automatically generated notes (e.g., where the automatically generated notes can be generated based on any of the fault detection server 140 parameters). The window 530 also provides the user with an option to edit the tenant name, the identification of the entity in charge of maintaining the physical structure 110 (or specific fault), the identification of the correction implementer, the vendor type, and/or the correction status. The user can also indicate whether the fault can be confirmed. This user feedback can be provided to the machine learning feedback system 144 to improve the operation of the fault detector 143. In further embodiments, the table 512 or another window, not shown, can depict some or all of the intervals during which a fault was observed, plots of the associated equipment's sensor measurements, fault detection accuracy (e.g., a percentage of faults that are confirmed by users as being faults), and/or a history of feedback provided by a user or set of users. Furthermore, any of the fault data can be viewed by fault type, by equipment type, by implementer by physical structure 110, by implementer across physical structures 110 (e.g., a contractor, such as a mechanical service company), by comparisons across physical structures 110, and/or over specific time periods.

As described herein, once a user (e.g., a building engineer, operator, administrator, etc.) has reviewed a fault in the user interface 500, the user can provide feedback on whether the fault has been verified (e.g., fault feedback) and what is being done to correct the fault (e.g., as indicated under correction implementer and correction status). If a user indicates that a fault cannot be addressed cost-effectively, the user may be prompted to provide an explanation under “building notes.” Similarly, if a user specifies that a reported fault is an incorrect diagnosis, the user may be prompted to provide an explanation under “building notes.”

In an embodiment, the fault detection server 140 (e.g., the fault detector 143) can analyze sensor 115 data at different time intervals (e.g., 1 day, 1 year, etc.). In some cases, a user may not address a pending fault. When the fault detection server 140 analyzes the sensor 115 data, the fault detection server 140 can generate an identical fault (e.g., a fault that corresponds to the same equipment, the same period of time or days observed, etc.). In such a situation, the user interface 500 can prompt the user to overwrite the previous fault with the newly detected fault.

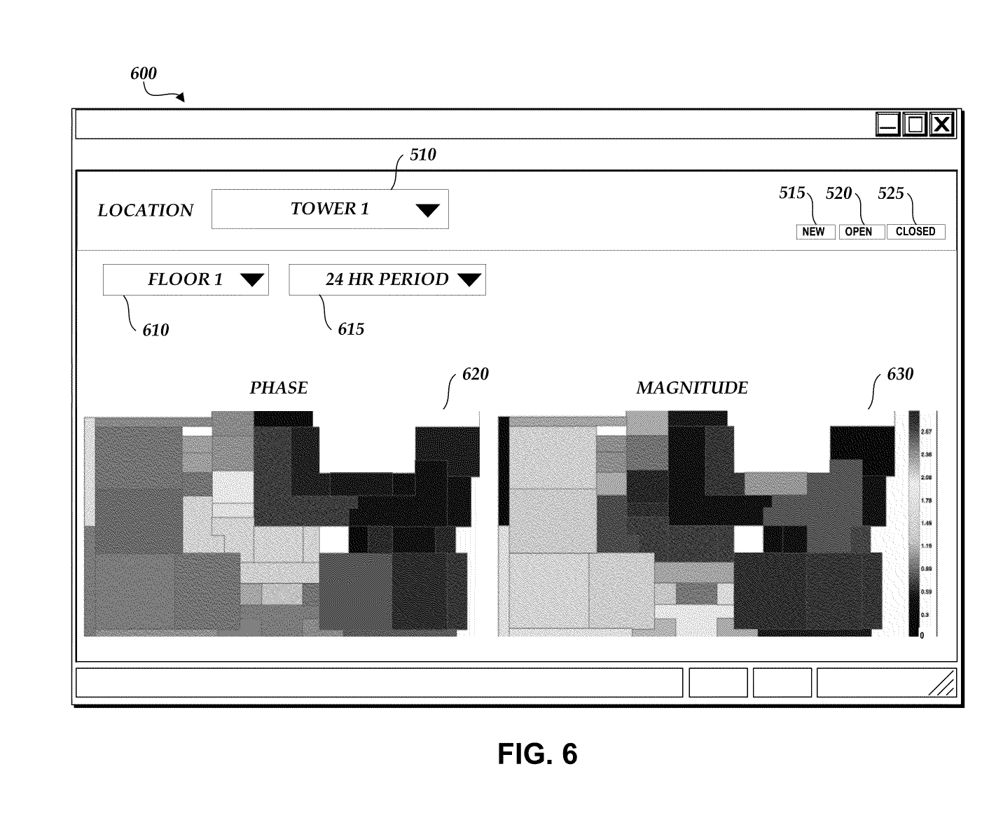

FIG. 6 illustrates a user interface 600 displaying a graphical representation of a spectral response by floor and period in the physical structure 110. In an embodiment, the user interface 600 is generated by the user interface generator 145. A user can cause the user interface 600 to be displayed by, for example, selecting windows 402, 404, and/or 406 in the user interface 400.

As illustrated in FIG. 6, the user can select the physical structure 110 via field 510 (e.g., Tower 1 in this case), a floor to view via field 610 (e.g., floor 1 in this case), and a time period to view via field 615 (e.g., a 24 hour period in this case). Selection of the physical structure 110, floor in the physical structure 110, and time period can cause the user interface 600 to display floor plans of the selected floor, where a first floor plan 620 displays a phase of the spectral response associated with the sensors 115 and/or components located on the selected floor and a second floor plan 630 displays a magnitude of the spectral response associated with the sensors 115 and/or components located on the selected floor. Each of the rooms in the floor plans 620 and 630 can be shaded to indicate a value of the phase or magnitude (e.g., a darker color can represent a higher phase or magnitude).

Thus, the user interface 600 allows a user to visually understand what locations in a physical structure 110 may have issues and which locations may not. For example, an area with a high magnitude or phase may indicate that indicator functions applied to the sensors 115 or components in that area are producing true conditions during the selected time period, which can indicate that a fault has occurred. Likewise, an area with a low magnitude or phase may indicate that indicator functions applied to the sensors 115 or components in that area are producing false conditions during the selected time period, which can indicate that a fault has not occurred.

### Example Process Flow

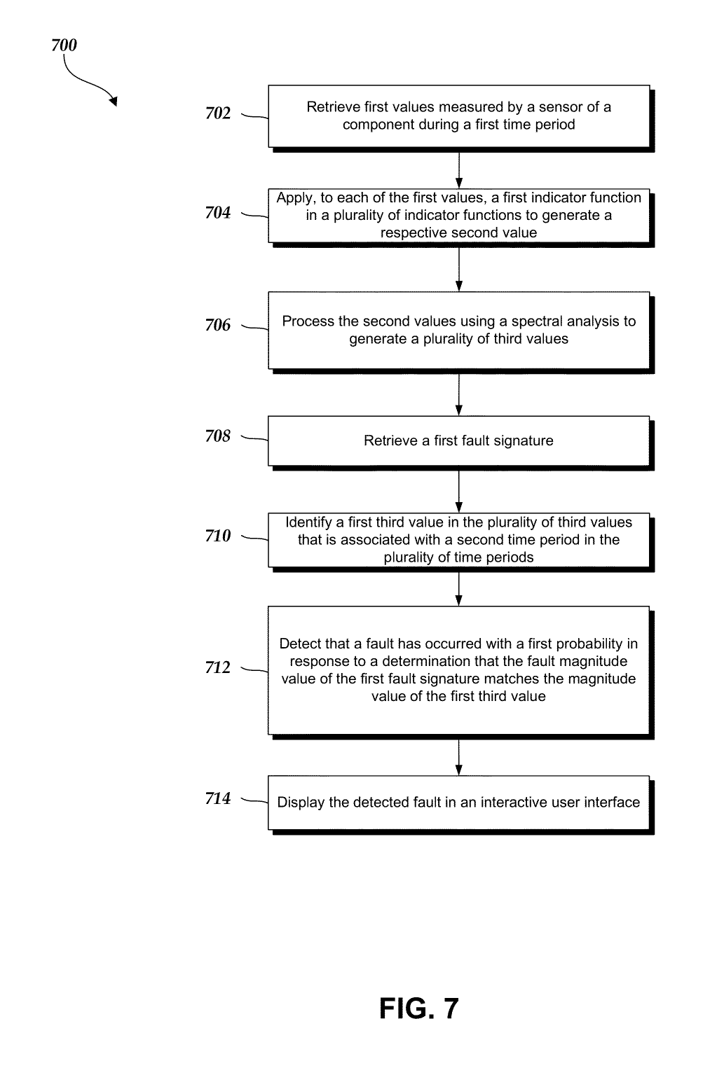

FIG. 7 is a flowchart 700 depicting an illustrative operation of detecting a fault in a data-based system. The method of FIG. 7 may be performed by various computing devices, such as by the fault detection server 140 described above. Depending on the embodiment, the method of FIG. 7 may include fewer and/or additional blocks and the blocks may be performed in an order different than illustrated.

In block 702, first values measured by a sensor of a component in the data-based system during a first time period are retrieved. For example, the component can be an HVAC system and the sensor can measure temperature values over a period of time.

In block 704, a first indicator function is applied to each of the first values to generate respective second values. For example, the indicator function can define an anomalous condition represented by a threshold value (e.g., a threshold value that corresponds to a setpoint) such that a true condition occurs if the threshold value is exceeded at a given time instance and a false condition occurs if the threshold value is not exceeded at a given time instance. A respective second value can either be a high value (e.g., if the threshold value is exceeded) or a low value (e.g., if the threshold value is not exceeded).

In block 706, the second values are processed using a spectral analysis to generate a plurality of third values. For example, the second values, which are time-series data in the time domain, can be converted into the frequency domain. By converting the second values into the frequency domain, the newly generated third values may correspond to a magnitude value, a phase value, a combination of magnitude and phase values associated with a specific time period (e.g., 24 hours, 168 hours, weekly, seasonally, annually, etc.).

In block 708, a first fault signature is retrieved. A first fault can define a fault via the combination of one or more indicator functions. The first fault signature can represent the first fault and be defined as having a certain magnitude value, a certain phase value, a certain combination of magnitude and phase values, and/or a certain score and/or rank for a given indicator function and time period.

In block 710, a first third value in the plurality of third values is identified that is associated with a second time period in the plurality of time periods. For example, a fault can be associated with a specific time period. The fault detection server 140 and/or a user via the user device 160 can select a specific time period to analyze for faults. The third values can correspond with different time periods, and the third value associated with the selected time period is identified.

In block 712, a fault is detected as occurring with a first probability in response to a determination that the fault magnitude value of the first fault signature matches the magnitude value of the first third value. For example, if the magnitude of the third value that corresponds with the selected time period matches the magnitude of the first fault signature, then the fault detection server 140 may determine that a fault occurred. The first probability may depend on how close the magnitude of the third value that corresponds with the selected time period is to the magnitude of the first fault signature (e.g., the closer the magnitudes, the higher the probability). In further embodiments, the fault detection server 140 also determines whether the indicator function corresponding to the third value is the same as the indicator function corresponding to the first fault signature before confirming that a fault is detected. In other embodiments, the magnitude of the third value is converted into a score and/or rank, the first fault signature is defined in terms of a score and/or rank (instead of a magnitude value), and the fault detection server 140 compares the scores and/or ranks to determine whether a fault occurred with the first probability. In alternative embodiments, the fault signature can be associated with a fault phase value and the phase value of the first third value can be compared with the fault phase value to determine whether a fault is detected as occurring with the first probability.

In block 714, the detected fault is displayed in an interactive user interface. In an embodiment, a user can provide feedback on whether a fault was accurately detected. If the detected fault was misdiagnosed (and is actually not a fault), this feedback can be provided to the fault detection server 140. Artificial intelligence (e.g., machine learning, support vector regression, support vector machines, ensemble methods, artificial neural networks, diffusion maps, etc.) can be used to modify the behavior of the fault detection server 140 such that a similar type of fault may not be identified as a fault in the future.

### Terminology

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry. The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating or otherwise vexing to user.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A fault detection system for detecting a fault in a data-based system comprising:
a computing system comprising one or more computer processors;
a database storing values measured by a sensor of a component in the data-based system; and
a computer readable storage medium that stores program instructions that instruct the computing system to at least:
retrieve, from the database, first values measured by the sensor during a first time period;
apply, to each of the first values, a first indicator function in a plurality of indicator functions to generate a respective second value;
process the second values using a spectral analysis to generate a plurality of third values, wherein each third value in the plurality of third values is associated with a magnitude value and a time period in a plurality of time periods, and wherein each third value in the plurality of third values corresponds with the first indicator function;
retrieve a plurality of fault signatures, wherein each fault signature is associated with an indicator function in the plurality of indicator functions and a fault magnitude value;
identify a first third value in the plurality of third values that is associated with a second time period in the plurality of time periods;
compare the magnitude value of the first third value with the fault magnitude value of a first fault signature in the plurality of fault signatures;
detect that a fault has occurred with a first probability in response to a determination that the fault magnitude value of the first fault signature matches the magnitude value of the first third value and that the indicator function associated with the first fault signature is the first indicator function; and
display the detected fault in an interactive user interface.

2. The fault detection system of claim 1, wherein the first fault signature is associated with the fault magnitude value and a second fault magnitude value, and wherein the computer readable storage medium further stores program instructions that instruct the computing system to at least:
retrieve, from the database, fourth values measured by a second sensor of the component during the first period of time;
apply, to each of the fourth values, a second indicator function in the plurality of indicator functions to generate a respective fifth value;
process the fifth values using the spectral analysis to generate a plurality of sixth values, wherein each sixth value in the plurality of sixth values is associated with a magnitude value and a time period in the plurality of time periods;
identify a first sixth value in the plurality of sixth values that is associated with the first time period;
compare the magnitude value of the first sixth value with the second fault magnitude value of the first fault signature; and
detect that the fault has occurred in response to a determination that the fault magnitude value of the first fault signature matches the magnitude value of the first third value and that the second fault magnitude value of the first fault signature matches the magnitude value of the first sixth value.

3. The fault detection system of claim 2, wherein the computer readable storage medium further stores program instructions that instruct the computing system to at least:
bin the first third value and the first sixth value; and
detect that a second fault has occurred in response to a determination that the binned first third value and the binned first sixth value exhibit a level of coincidence that exceeds a first threshold value and exhibit a level of severity that exceeds a second threshold value.

4. The fault detection system of claim 3, wherein the level of coincidence corresponds with a level of similarity between two magnitude values.

5. The fault detection system of claim 1, wherein the first indicator function defines an anomalous condition represented by a threshold value, and wherein the computer readable storage medium further stores program instructions that instruct the computing system to at least, for each of the first values:
determine whether the respective first value exceeds the threshold value;
assign the respective second value a high value in response to a determination that the respective first value exceeds the threshold value; and
assign the respective second value a low value lower than the high value in response to a determination that the respective first value does not exceed the threshold value.

6. The fault detection system of claim 1, wherein the computer readable storage medium further stores program instructions that instruct the computing system to at least:
receive, via the interactive user interface, an indication that the detected fault is misdiagnosed;
process the indication using artificial intelligence; and
determine whether to display a second fault that corresponds with the detected fault in the interactive user interface at a later time based on results of the processing.

7. The fault detection system of claim 1, wherein the component comprises one of an HVAC system, a variable air volume system, an air handling unit, a heat pump, or a fan powered box.

8. The fault detection system of claim 1, wherein the computer readable storage medium further stores program instructions that cause the computing system to process the second values using a Koopman mode analysis.

9. A computer-implemented method for detecting a data-based system fault comprising:
as implemented by a fault detection server comprising one or more computing devices, the fault detection server configured with specific executable instructions,
retrieving, from a sensor database, first values measured by a sensor of a component during a first time period;
applying, to each of the first values, a first indicator function in a plurality of indicator functions to generate a respective second value;
processing the second values using a spectral analysis to generate a plurality of third values, wherein each third value in the plurality of third values is associated with a magnitude value and a time period in a plurality of time periods;
retrieving a plurality of fault signatures, wherein each fault signature is associated with an indicator function in the plurality of indicator functions and a fault magnitude value;
identifying a first third value in the plurality of third values that is associated with a second time period in the plurality of time periods;
comparing the magnitude value of the first third value with the fault magnitude value of a first fault signature in the plurality of fault signatures;
detecting that a fault has occurred with a first probability in response to a determination that the fault magnitude value of the first fault signature falls within a range of the magnitude value of the first third value; and
displaying the detected fault in an interactive user interface.

10. The computer-implemented method of claim 9, wherein the first fault signature is associated with the fault magnitude value and a second fault magnitude value, and wherein the method further comprises:
retrieving, from the sensor database, fourth values measured by a second sensor of the component during the first period of time;
applying, to each of the fourth values, a second indicator function in the plurality of indicator functions to generate a respective fifth value;
processing the fifth values using the spectral analysis to generate a plurality of sixth values, wherein each sixth value in the plurality of sixth values is associated with a magnitude value and a time period in the plurality of time periods;
identifying a first sixth value in the plurality of sixth values that is associated with the first time period;
comparing the magnitude value of the first sixth value with the second fault magnitude value of the first fault signature; and
detecting that the fault has occurred in response to a determination that the fault magnitude value of the first fault signature matches the magnitude value of the first third value and that the second fault magnitude value of the first fault signature matches the magnitude value of the first sixth value.

11. The computer-implemented method of claim 10, further comprising:
binning the first third value and the first sixth value; and
detecting that a second fault has occurred in response to a determination that the binned first third value and the binned first sixth value exhibit a level of coincidence that exceeds a first threshold value and exhibit a level of severity that exceeds a second threshold value.

12. The computer-implemented method of claim 11, wherein the level of coincidence corresponds with a level of similarity between two magnitude values.

13. The computer-implemented method of claim 9, wherein the first indicator function defines an anomalous condition represented by a threshold value, and wherein applying, to each of the first values, a first indicator function comprises, for each of the first values:
determining whether the respective first value exceeds the threshold value;
assigning the respective second value a high value in response to a determination that the respective first value exceeds the threshold value; and
assigning the respective second value a low value lower than the high value in response to a determination that the respective first value does not exceed the threshold value.

14. The computer-implemented method of claim 9, wherein the first third value corresponds with the first indicator function, and wherein detecting that a fault has occurred comprises detecting that the fault has occurred in response to a determination that the fault magnitude value of the first fault signature matches the magnitude value of the first third value and the indicator function associated with the first fault signature is the first indicator function.

15. The computer-implemented method of claim 9, further comprising:
receiving, via the interactive user interface, an indication that the detected fault is misdiagnosed;
processing the indication using artificial intelligence; and
determining whether to display a second fault that corresponds with the detected fault in the interactive user interface at a later time based on results of the processing.

16. The computer-implemented method of claim 9, wherein the component comprises one of an HVAC system, a variable air volume system, an air handling unit, a heat pump, or a fan powered box.

17. The computer-implemented method of claim 9, wherein processing the second values using a spectral analysis comprises processing the second values using a Koopman mode analysis.

18. A non-transitory computer-readable medium having stored thereon a spectral analyzer and a fault detector for identifying faults in a data-based system, the spectral analyzer and fault detector comprising executable code that, when executed on a computing device, implements a process comprising:
retrieving first values measured by a sensor of a component during a first time period;
applying, to each of the first values, a first indicator function in a plurality of indicator functions to generate a respective second value;
processing the second values using a spectral analysis to generate a plurality of third values, wherein each third value in the plurality of third values is associated with a magnitude value and a time period in a plurality of time periods;
retrieving a plurality of fault signatures, wherein each fault signature is associated with a fault magnitude value;
identifying a first third value in the plurality of third values that is associated with a second time period in the plurality of time periods;
comparing the magnitude value of the first third value with the fault magnitude value of a first fault signature in the plurality of fault signatures;
detecting that a fault has occurred with a first probability in response to a determination that the fault magnitude value of the first fault signature falls within a range of the magnitude value of the first third value; and
displaying the detected fault in an interactive user interface.

19. The non-transitory computer-readable medium of claim 18, wherein the first indicator function defines an anomalous condition represented by a threshold value, and wherein the executable code further implement a processing comprising, for each of the first values:
determining whether the respective first value exceeds the threshold value;
assigning the respective second value a high value in response to a determination that the respective first value exceeds the threshold value; and
assigning the respective second value a low value lower than the high value in response to a determination that the respective first value does not exceed the threshold value.

20. The non-transitory computer-readable medium of claim 18, wherein the executable code further implement a processing comprising:
receiving, via the interactive user interface, an indication that the detected fault is misdiagnosed;
processing the indication using artificial intelligence; and
determining whether to display a second fault that corresponds with the detected fault in the interactive user interface at a later time based on results of the processing.
